(19) United States
(12) Patent Application Publication
(10) Pub. No.: US 2026/0213794 A1
(43) Pub. Date: Jul. 23, 2026

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Jungang GE, Chengdu, Sichuan (CN); Yingchang LIANG, Chengdu, Sichuan (CN); Shuo WANG, Beijing (CN); Chen SUN, Beijing (CN)

(73) Assignee: Sony Group Corporation, Tokyo (JP)

(21) Appl. No.: 19/140,402

(22) PCT Filed: Dec. 29, 2023
(86) PCT No.: PCT/CN2023/143008

§ 371 Date: Jun. 18, 2025

(30) Foreign Application Priority Data
Jan. 5, 2023 (CN) 202310012024.8

(51) Int. Cl. H04B 7/04; H04B 7/06

(52) U.S. Cl. CPC H04B 7/04013; H04B 7/0634

(57) ABSTRACT

The present application relates to an electronic device and method for wireless communication, and a computer-readable storage medium. The electronic device for wireless communication comprises a processing circuit, wherein the processing circuit is configured to receive at least one sensing signal from a primary user by means of at least one equivalent channel, said channel being established between the electronic device and the primary user by means of at least one reconfigurable intelligent surface and corresponding to a direct channel between the primary user and the electronic device, so as to determine whether the primary user occupies a predetermined frequency band used by the direct channel and the at least one equivalent channel. (FIG. 1)

This application claims priority to Chinese Patent Application No. 202310012024.8 titled “ELECTRONIC DEVICE AND METHOD FOR WIRELESS COMMUNICATION, AND COMPUTER-READABLE STORAGE MEDIUM”, filed on Jan. 5, 2023 with the China National Intellectual Property Administration (CNIPA), which is incorporated herein by reference in its entirety.

### FIELD

The present disclosure relates to the technical field of wireless communications, and in particular to an electronic apparatus and a method for wireless communications, and a computer-readable storage medium. More specifically, the present disclosure relates to spectrum sensing by means of a reconfigurable intelligent surface (spectrum sensing with assistance of a reconfigurable intelligent surface).

### BACKGROUND

Citizens Broadband Radio Service (CBRS) is a 150 Mhz-wide (3550 Mhz to 3700 MHz) frequency band at 3.5 GHz specified by the United States. It has a wide range of uses, such as large-scale network expansion of operators, fixed wireless access for backhaul, enterprise and municipal network construction, and the like. CBRS defines three layers of spectrum usage rights for users: Incumbents, Priority Access License (PAL), and General Authorized Access (GAA). These layers share the CBRS spectrum, and therefore the Federal Communications Commission requires that GAA users not interfere with PAL or legacy operator users, and PAL users not interfere with legacy operator users. Such possible interference problem needs to be managed by the Spectrum Access System (SAS) so that a user newly accessing the CBRS frequency band do not interfere with other users already using nearby radio frequency bands. Apparently, how users determine an occupancy status of a CBRS frequency band before accessing is one of the key issues in implementing SAS.

Spectrum sensing technology allows users to obtain an occupancy status of a given frequency band through various signal detection and processing methods, and plays an irreplaceable role in SAS. In order to accurately perceive a spectrum occupancy status in a conventional spectrum sensing system, it is necessary to increase a sampling time to obtain more signal samples, which occupies the time for subsequent data transmission. Therefore, the conventional spectrum sensing system has to improve the accuracy of spectrum sensing by sacrificing data transmission time. This approach seriously limits the efficiency of spectrum sharing.

### SUMMARY

A brief summary of the present disclosure is given below, to provide a basic understanding of some aspects of the present disclosure. It should be understood that the following summary is not an exhaustive summary of the present disclosure. It is not intended to determine a key or important part of the present disclosure, nor does it intend to limit the scope of the present disclosure. The purpose is merely to present some concepts in a simplified form, as a preamble to a more detailed description discussed later.

According to an aspect of the present disclosure, an electronic apparatus for wireless communications is provided. The electronic apparatus includes processing circuitry, configured to: receive at least one sensing signal from a primary user, through at least one equivalent channel corresponding to a direct channel between the primary user and the electronic apparatus, for judging whether the primary user occupies a predetermined frequency band used by the direct channel and the at least one equivalent channel, wherein the at least one equivalent channel is established between the electronic apparatus and the primary user by means of at least one reconfigurable intelligent surface.

In the embodiments according to the present disclosure, the electronic apparatus improves channel quality in spectrum sensing based on the equivalent channel established through the reconfigurable intelligent surface, thereby enabling fast and accurate sensing of a spectrum status of the primary user. Especially in a scenario having extremely low signal-to-noise ratio, an accuracy of spectrum sensing can be greatly improved and thereby an efficiency of spectrum sharing is improved.

According to an aspect of the present disclosure, an electronic apparatus for wireless communications is provided. The electronic apparatus includes processing circuitry, configured to: judge, based on at least one sensing signal received by each secondary user among multiple secondary users through at least one equivalent channel corresponding to a direct channel between a primary user and the secondary user, whether the primary user occupies a predetermined frequency band used by the direct channel and the at least one equivalent channel, where the at least one equivalent channel corresponding to each secondary user is established between the primary user and the secondary user by means of at least one reconfigurable intelligent surface.

In the embodiments according to the present disclosure, the electronic apparatus improves channel quality in spectrum sensing based on the equivalent channel established through the reconfigurable intelligent surface, thereby enabling fast and accurate sensing of a spectrum status of the primary user. Especially in a scenario having extremely low signal-to-noise ratio, an accuracy of spectrum sensing can be greatly improved and thereby an efficiency of spectrum sharing is improved.

According to an aspect of the present disclosure, a method for wireless communications is provided. The method includes: receiving at least one sensing signal from a primary user, through at least one equivalent channel corresponding to a direct channel between the primary user and an electronic apparatus, for judging whether the primary user occupies a predetermined frequency band used by the direct channel and the at least one equivalent channel, wherein the at least one equivalent channel is established between the electronic apparatus and the primary user by means of at least one reconfigurable intelligent surface.

According to an aspect of the present disclosure, a method for wireless communications is provided. The method includes: judging, based on at least one sensing signal received by each secondary user among multiple secondary users through at least one equivalent channel corresponding to a direct channel between a primary user and the secondary user, whether the primary user occupies a predetermined frequency band used by the direct channel and the at least one equivalent channel, where the at least one equivalent channel corresponding to each secondary user is established between the primary user and the secondary user by means of at least one reconfigurable intelligent surface.

According to other aspects of the present disclosure, there are further provided a computer program code and a computer program product for implementing the above-described methods for wireless communication, and a computer-readable storage medium having the computer program code for implementing the methods for wireless communication recorded thereon.

### BRIEF DESCRIPTION OF THE DRAWINGS

For a further illustration of the above and other advantages and features of the present disclosure, embodiments of the present disclosure are described in detail hereinafter in conjunction with accompanying drawings. The drawings, together with the detailed description below, are incorporated into and form a part of the specification. Elements having the same function and structure are denoted by same reference signs. It should be noted that the drawings illustrate merely typical embodiments of the present disclosure and should not be construed as a limitation to the scope of the present disclosure. In the drawings:

FIG. 1 shows a block diagram of functional modules of an electronic apparatus for wireless communications according to an embodiment of the present disclosure;

FIG. 2 shows an example of a direct channel and equivalent channels between the electronic apparatus and the primary user according to an embodiment of the present disclosure;

FIG. 3 is an information interaction diagram showing spectrum sensing performed by an electronic apparatus via a reconfigurable intelligent surface according to an embodiment of the present disclosure;

FIG. 4 shows a block diagram of functional modules of an electronic apparatus for wireless communications according to a further embodiment of the present disclosure;

FIG. 5 is an information interaction diagram showing spectrum sensing performed by an electronic apparatus via a reconfigurable intelligent surface according to an embodiment of the present disclosure;

FIG. 6 is a diagram showing an effect of spectrum sensing using a reconfigurable intelligent surface according to an embodiment of the present disclosure;

FIG. 7 shows a flow chart of a method for wireless communications according to an embodiment of the present disclosure;

FIG. 8 shows a flow chart of a method for wireless communications according to another embodiment of the present disclosure;

FIG. 9 is a block diagram showing a first example of a schematic configuration of an eNB or gNB to which the technology of the present disclosure is applicable;

FIG. 10 is a block diagram showing a second example of a schematic configuration of an eNB or gNB to which the technology of the present disclosure is applicable;

FIG. 11 is a block diagram showing an example of a schematic configuration of a smart phone to which the technology of the present disclosure is applicable;

FIG. 12 is a block diagram showing an example of a schematic configuration of an automobile navigation device to which the technology of the present disclosure is applicable; and

FIG. 13 is a block diagram of an exemplary structure of a universal personal computer in which the methods and/or apparatuses and/or systems according to the embodiments of the present disclosure is applicable.

### DETAILED DESCRIPTION

Hereinafter, exemplary embodiments of the present disclosure will be described in conjunction with the accompanying drawings. For the sake of clarity and conciseness, not all features of an actual embodiment are described in the specification. However, it is to be appreciated that numerous implementation-specific decisions shall be made while implementing any of such actual embodiments so as to achieve specific objectives of a developer, for example, to comply with system- and business-related constraining conditions which vary from one implementation to another. Furthermore, it should be understood that the development work, although may be complicated and time-consuming, is only a routine task for those skilled in the art benefiting from the present disclosure.

Here, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

When a PAL user is using the CBRS frequency band and a GAA user fails to detect it, access of the GAA user to the CBRS frequency band causes serious interference to the PAL user.

According to an embodiment of the present disclosure, a scenario in which one PAL is deployed in a spectrum license authorized area, and one or more GAA users perform spectrum sensing before accessing the PAL frequency band is provided.

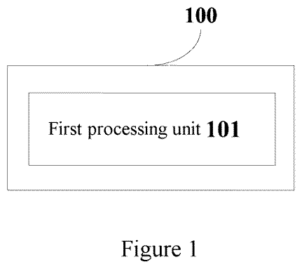

FIG. 1 shows a block diagram of functional modules of an electronic apparatus 100 for wireless communications according to an embodiment of the present disclosure.

As shown in FIG. 1, the electronic apparatus 100 includes a first processing unit 101, which may receive at least one sensing signal from a primary user, through at least one equivalent channel corresponding to a direct channel between the primary user and the electronic apparatus 100, for judging whether the primary user occupies a predetermined frequency band used by the direct channel and the at least one equivalent channel, wherein the at least one equivalent channel is established between the electronic apparatus 100 and the primary user by means of at least one reconfigurable intelligent surface (RIS). For example, channel quality of the equivalent channel established through RIS may be better than channel quality of the direct channel.

The first processing unit 101 may be implemented by one or more processing circuits. The processing circuitry may be implemented as a chip, for example.

The electronic apparatus 100 may be provided on a base station side or be communicatively connected to a base station. Here, it should be noted that the electronic apparatus 100 may be implemented at a chip level or at an apparatus level. For example, the electronic apparatus 100 may operate as the base station itself and may further include a memory, a transceiver (not shown), and other external devices. The memory may store related data information and programs that the base station needs to execute to achieve various functions. The transceiver may include one or more communication interfaces to support communications with different devices (such as user equipment (UE), another base station, and the like). An implementation of the transceiver is not specifically limited here.

The base station may be an eNB or gNB, as an example.

The wireless communication system according to the present disclosure may be a 5G NR (New Radio) communication system. Further, the wireless communication system according to the present disclosure may include a non-terrestrial network (NTN). Alternatively, the wireless communication system according to the present disclosure may further include a terrestrial network (TN). In addition, those skilled in the art may understand that the wireless communication system according to the present disclosure may be a 4G or 3G communication system.

As an example, the primary user may be a PAL user. The electronic apparatus 100 is, for example, a GAA user.

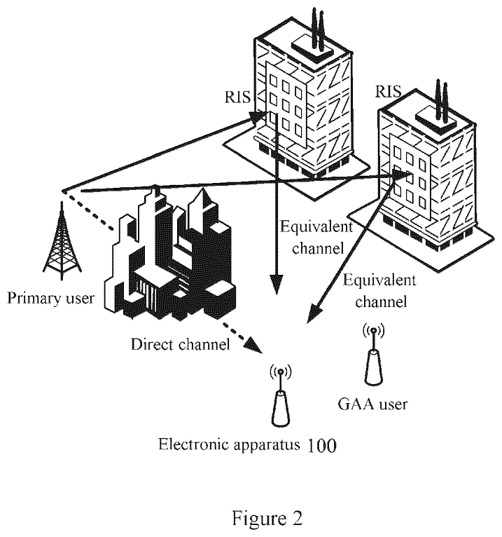

FIG. 2 shows an example of a direct channel and equivalent channels between the electronic apparatus 100 and the primary user according to an embodiment of the present disclosure. As shown in FIG. 2, the dashed arrow represents a direct channel between the primary user and the electronic apparatus 100, and the solid arrow represents an equivalent channel (which may be referred to as an equivalent (reflected) channel or virtual link) established between the primary user and the electronic apparatus 100 via the reconfigurable intelligent surfaces. In FIG. 2, an example in which two equivalent channels between a primary user and an electronic apparatus 100 are established via reconfigurable intelligent surfaces is illustrated. Although not shown, two equivalent channels may be further established between the primary user and another GAA user in FIG. 2 via reconfigurable intelligent surfaces. For example, as shown in FIG. 2, there is an obstacle between the electronic apparatus 100 and the primary user. Therefore, the equivalent channel established through the RIS satisfies a better channel quality than the direct channel. With the equivalent channel, an energy of a signal received by the electronic apparatus 100 from the primary user can be improved. The reconfigurable intelligent surface is easy to deploy, environmentally friendly, and highly compatible, and is applied in almost all existing wireless communication systems.

For example, the direct channel and the at least one equivalent channel use the same predetermined frequency band.

In order to accurately perceive a spectrum occupancy status in a conventional spectrum sensing system, it is necessary to increase a sampling time to obtain more signal samples, which occupies the time for subsequent data transmission. Therefore, the conventional spectrum sensing system has to improve the accuracy of spectrum sensing by sacrificing data transmission time. Especially in a scenario having extremely low signal-to-noise ratio, a conventional spectrum sensing systems cannot achieve an accuracy rate sufficient to support the spectrum access system in the CBRS band, resulting in an interference problem that the spectrum usage rights of the three-layer users stipulated by CBRS cannot be guaranteed, and the efficiency and reliability of the CBRS spectrum access system is seriously affected. Hence, the conventional spectrum sensing system improving the accuracy of spectrum sensing by sacrificing data transmission time seriously limits the efficiency of spectrum sharing.

In the embodiments according to the present disclosure, the electronic apparatus 100 improves channel quality in spectrum sensing based on the equivalent channel established through the reconfigurable intelligent surface, thereby enabling fast and accurate sensing of a spectrum status of the primary user (That is, the spectrum status of the primary user can be accurately perceived in a short sampling time). Especially in the scenario having extremely low signal-to-noise ratio (for example, the situation where there is an obstacle (i.e., occlusion) between the electronic apparatus 100 and the primary user as shown in FIG. 2 is an example of a scenario that causes extremely low signal-to-noise ratio), the accuracy of spectrum sensing can be significantly improved and the efficiency of spectrum sharing can be improved.

As an example, reflection coefficient(s) of a reflection unit of each of the at least one reconfigurable intelligent surface is set based on an optimal reflection coefficient matrix corresponding to the reconfigurable intelligent surface. The optimal reflection coefficient matrix is determined so as to maximize channel gain of channel(s) obtained based on the at least one equivalent channel. In this way, channel quality in spectrum sensing can be further improved. The reflection coefficient matrix may include a phase matrix, and the reflection coefficient of the reflection unit may include a phase of the reflection unit.

As an example, in a case where a change in a communication system to which the electronic apparatus 100 belongs satisfies predetermined conditions, the optimal reflection coefficient matrix is re-determined.

As an example, the predetermined conditions include an access and/or exit of equipment in the communication system, and/or the predetermined condition includes change(s) in position(s) of the electronic apparatus 100 and/or the primary user. An access and/or exit of equipment in the communication system, and/or change(s) in position(s) of the electronic apparatus 100 and/or the primary user may be considered an environmental change in the communication system. Those skilled in the art may set other predetermined conditions, which is not described here.

As an example, the first processing unit 101 may be configured to determine, based on channel statistical information of channels between the at least one reconfigurable intelligent surface and the primary user as well as the electronic apparatus 100, an optimal reflection coefficient matrix respectively corresponding to the at least one reconfigurable intelligent surface. The channel statistical information is a mean value of channel coefficient of a channel, for example. Those skilled in the art may envisage other examples of the channel statistical information, which is not described here.

As an example, the at least one reconfigurable intelligent surface includes one reconfigurable intelligent surface. The first processing unit 101 may be configured to determine the optimal reflection coefficient matrix to be: a reflection coefficient matrix, based on which channel gain of an equivalent channel from the primary user to the electronic apparatus 100 via the one reconfigurable intelligent surface is maximized. For example, this situation corresponds to a scenario in which there is one GAA user (i.e., the electronic apparatus 100) and one RIS in the communication system.

As an example, the first processing unit 101 may be configured to determine the optimal reflection coefficient matrix Φ* through the following equation:

$${Φ}^{*} = arg {max}_{Φ} {\vert {g}^{H} Φ f \vert}^{2}$$

where Φ represents a reflection coefficient matrix corresponding to the one reconfigurable intelligent surface,
f represents a mean value of channel coefficient of a channel between the one reconfigurable intelligent surface and the primary user, and g represents a mean value of channel coefficient of a channel between the one reconfigurable intelligent surface and the electronic apparatus 100,
   |g^{H}Φf|² represents channel gain of an equivalent channel from the primary user to the electronic apparatus 100 via the one reconfigurable intelligent surface,
H represents a transpose operation, and

$$arg {max}_{Φ} {\vert {g}^{H} Φ f \vert}^{2}$$

represents to traverse Φ and select Φ which maximizes |g^{H}Φf|² as the optimal reflection coefficient matrix Φ*.

As an example, the electronic apparatus 100 measures f and g at the reconfigurable intelligent surface. The electronic apparatus 100 adjusts the RIS reflection coefficient matrix Φ based on the obtained optimal reflection coefficient matrix Φ*, to maximize channel gain of the equivalent reflection channel. For example, the RIS optimal reflection coefficient matrix is calculated through

$${Φ}_{1}^{*} , … , {Φ}_{L}^{*} = arg {max}_{{Φ}_{1} , … , {Φ}_{L}} {\vert {\sum }_{l = 1}^{L} {g}_{l}^{H} {Φ}_{l} {f}_{l} \vert}^{2}$$

The control link of the RIS sets the reflection coefficient of each reflection unit accordingly.

As an example, the at least one reconfigurable intelligent surface includes L reconfigurable intelligent surfaces, and the at least one equivalent channel includes L equivalent channels, where L is a positive integer greater than 1. The first processing unit 101 may be configured to determine respective optimal reflection coefficient matrices corresponding to the L reconfigurable intelligent surfaces to be: reflection coefficient matrices, based on which channel gain of a combined channel formed by the L equivalent channels from the primary user to the electronic apparatus 100 via the L reconfigurable intelligent surfaces is maximized. For example, this situation corresponds to a scenario in which there is one GAA user (i.e., the electronic apparatus 100) and L RISs in the communication system.

As an example, the processing unit 101 may be configured to determine the optimal reflection coefficient matrices

$${Φ}_{1}^{*} , … , {Φ}_{L}^{*}$$

corresponding to the L reconfigurable intelligent surfaces through the following equation:

$${Φ}^{*} = arg {max}_{Φ} {\vert {g}^{H} Φ f \vert}^{2} .$$

where l represents a positive integer from 1 to L,
Φₗ represents a reflection coefficient matrix corresponding to the l-th reconfigurable intelligent surface,
fₗ represents a mean value of channel coefficient of a channel between the l-th reconfigurable intelligent surface and the primary user, and gₗ represents a mean value of channel coefficient of a channel between the l-th reconfigurable intelligent surface and the electronic apparatus 100,

$${\vert {\sum }_{l = 1}^{L} {g}_{l}^{H} {Φ}_{l} {f}_{l} \vert}^{2}$$

represents channel gain of a combined channel formed by the L equivalent channels from the primary user to the electronic apparatus 100 via the L reconfigurable intelligent surfaces,
H represents a transpose operation, and

$$arg {max}_{{Φ}_{1} , … , {Φ}_{L}} {\vert {\sum }_{l = 1}^{L} {g}_{l}^{H} {Φ}_{l} {f}_{l} \vert}^{2}$$

represents to traverse Φ₁, . . . , Φ_{L} and select Φ₁, . . . , Φ_{L} which maximize

$${\vert {\sum }_{l = 1}^{L} {g}_{l}^{H} {Φ}_{l} {f}_{l} \vert}^{2}$$

as the optimal reflection coefficient matrices

$${Φ}_{1}^{*} , … , {Φ}_{L}^{*} .$$

As an example, the electronic apparatus 100 measures fₗ and gₗ at each of the RISs. Furthermore, the electronic apparatus 100 adjusts the reflection coefficient matrix of each RIS to maximize the gain of the combined channel (also referred to as an overall equivalent reflection channel) formed by the L equivalent channels, that is, calculates the optimal reflection coefficient matrix of each RIS through

$${Φ}_{1}^{*} , … , {Φ}_{L}^{*} = arg {max}_{{Φ}_{1} , … , {Φ}_{L}} {\vert {\sum }_{l = 1}^{L} {g}_{l}^{H} {Φ}_{l} {f}_{l} \vert}^{2} .$$

The control link of the RIS sets the reflection coefficient of each reflection unit accordingly based on the obtained optimal reflection coefficient matrix

$${Φ}_{1}^{*} , … , {Φ}_{L}^{*} .$$

As an example, the first processing unit 101 may be configured to: compare the calculated statistics about the at least one sensing signal with a predetermined threshold, to determine whether the primary user occupies the predetermined frequency band. For example, the statistics of a sensing signal may be calculated through existing methods in the art. For example, the statistics related to at least one sensing signal may be received signal energy of the at least one sensing signal. The electronic apparatus 100 may compare the received signal energy with the predetermined threshold to determine whether the primary user occupies the predetermined frequency band, that is, to obtain a spectrum occupancy status of the primary user. When detecting the spectrum occupancy status, in addition to energy detection, feature value detection may be performed (for example, comparing a feature value of the at least one sensing signal with a predetermined threshold to determine whether the primary user occupies the predetermined frequency band), which is not described in detail here.

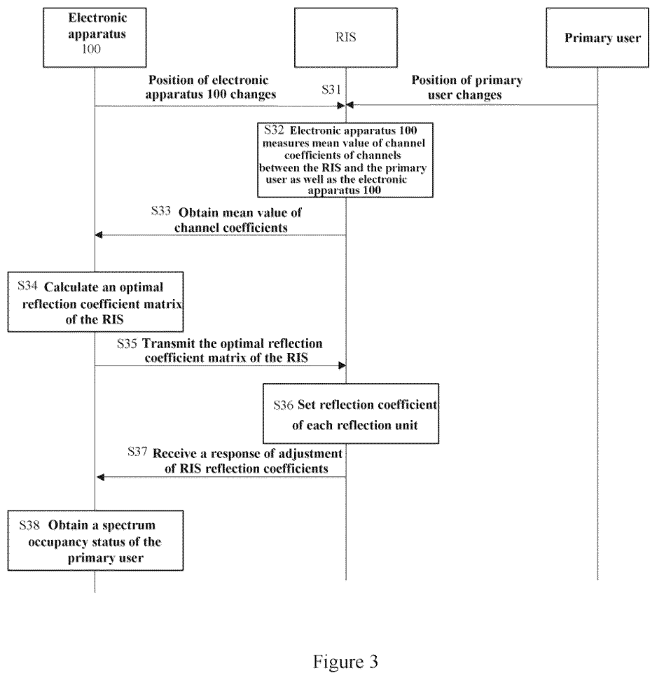

FIG. 3 is an information interaction diagram showing spectrum sensing performed by an electronic apparatus 100 via a reconfigurable intelligent surface according to an embodiment of the present disclosure. Although only one RIS is shown in FIG. 3, a situation having multiple RISs is possible.

In S31, assuming that a position(s) of the electronic apparatus 100 and/or a primary user changes, it is necessary to re-determine an optimal reflection coefficient matrix of the RIS.

In S32, the electronic apparatus 100 measures a mean value of channel coefficient of a channel between the RIS and the primary user and a mean value of channel coefficient of a channel between the RIS and the electronic apparatus 100.

In S33, the electronic apparatus 100 obtains the mean value of channel coefficients.

In S34, the electronic apparatus 100 calculates an optimal reflection coefficient matrix of the RIS.

In S35, the electronic apparatus 100 transmits the optimal reflection coefficient matrix of the RIS to the RIS.

In S36, the RIS sets a reflection coefficient of each reflection unit according to the optimal reflection coefficient matrix.

In S37, the electronic apparatus 100 receives a response of the adjustment of RIS reflection coefficients.

In S38, the electronic apparatus 100 compares the calculated statistics about the sensing signal with a predetermined threshold to obtain a spectrum occupancy status of the primary user.

In a scenario where there are multiple GAA users in the communication system, simultaneous sensing of the same spectrum by multiple GAA users is called collaborative spectrum sensing. In a collaborative spectrum sensing system, multiple GAA users detect an occupancy status of a same spectrum through a spectrum sensing algorithm. These users report the sensed data or sensing results to a fusion center (FC). The fusion center then fuses the sensing data or results from multiple GAA users by using a fusion algorithm, to judge an occupancy status of the sensed frequency band.

As an example, the first processing unit 101 may be configured to transmit channel statistical information of channels between the at least one reconfigurable intelligent surface and the primary user as well as the electronic apparatus 100 to the fusion center, for the fusion center to determine the optimal reflection coefficient matrix based on the channel statistical information and channel statistical information received from other electronic apparatus (that is, other GAA users).

As an example, the first processing unit may be configured to: transmit the calculated statistics about the at least one sensing signal to the fusion center, for the fusion center to determine whether the primary user occupies the predetermined frequency band.

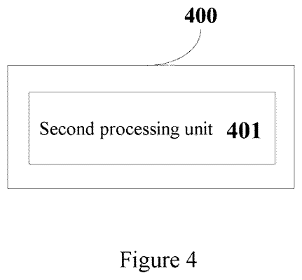

An electronic apparatus for wireless communications is further provided according to another embodiment of the present disclosure. FIG. 4 shows a block diagram of functional modules of an electronic apparatus 400 for wireless communications according to a further embodiment of the present disclosure.

As shown in FIG. 4, the electronic apparatus 400 includes a second processing unit 401. The second processing unit 401 may be configured to: judge, based on at least one sensing signal received by each secondary user among multiple secondary users through at least one equivalent channel corresponding to a direct channel between a primary user and the secondary user, whether the primary user occupies a predetermined frequency band used by the direct channel and the at least one equivalent channel, where the at least one equivalent channel corresponding to each secondary user is established between the primary user and the secondary user by means of at least one reconfigurable intelligent surface.

The second processing unit 401 may be implemented by one or more processing circuits. The processing circuitry may be implemented as a chip, for example.

The electronic apparatus 400 may be provided on a base station side or be communicatively connected to a base station. Here, it should be noted that the electronic apparatus 400 may be implemented at a chip level or at an apparatus level. For example, the electronic apparatus 400 may operate as the base station itself and may further include a memory, a transceiver (not shown), and other external devices. The memory may store related data information and programs that the base station needs to execute to achieve various functions. The transceiver may include one or more communication interfaces to support communications with different devices (such as user equipment (UE), another base station, and the like). An implementation of the transceiver is not specifically limited here.

The base station may be an eNB or gNB, as an example.

As an example, the electronic apparatus 400 may be implemented as other devices in the SAS that are different from the base station.

As an example, the secondary user may be a GAA user, such as the electronic apparatus 100 mentioned above, and the primary user may be a PAL user. As an example, the electronic apparatus 400 may be a fusion center as in the embodiment of the electronic apparatus 100. As an example, functions of the electronic apparatus 400 may be implemented in entities such as a SAS and a CxM (coexistence manager).

The wireless communication system according to the present disclosure may be a 5G NR communication system. Further, the wireless communication system according to the present disclosure may include a non-terrestrial network. Alternatively, the wireless communication system according to the present disclosure may further include a terrestrial network. In addition, those skilled in the art may understand that the wireless communication system according to the present disclosure may be a 4G or 3G communication system.

In the embodiments according to the present disclosure, the electronic apparatus 400 improves channel quality in spectrum sensing based on the equivalent channel established through the reconfigurable intelligent surface, thereby enabling fast and accurate sensing of a spectrum status of the primary user. Especially in a scenario having extremely low signal-to-noise ratio, an accuracy of spectrum sensing can be greatly improved.

As an example, reflection coefficient(s) of a reflection unit of each of the at least one reconfigurable intelligent surface is set based on an optimal reflection coefficient matrix corresponding to the reconfigurable intelligent surface. The optimal reflection coefficient matrix is determined so as to maximize channel gain of channel(s) obtained based on the at least one equivalent channel. In this way, channel quality in spectrum sensing can be further improved.

As an example, in a case where a change in a communication system to which the primary user and the plurality of secondary users belongs satisfy predetermined conditions, the optimal reflection coefficient matrix is re-determined.

As an example, the predetermined conditions include an access and/or exit of equipment in the communication system, and/or the predetermined condition includes change(s) in position(s) of the primary user and/or at least one secondary user in the plurality of secondary user. Those skilled in the art may set other predetermined conditions, which is not described here.

As an example, the processing unit 401 may be configured to determine, based on channel statistical information of channels between the at least one reconfigurable intelligent surface and the primary user as well as each secondary user among the plurality of secondary users obtained from the secondary user, an optimal reflection coefficient matrix respectively corresponding to the at least one reconfigurable intelligent surface.

As an example, the at least one reconfigurable intelligent surface includes one reconfigurable intelligent surface, and the at least one equivalent channel corresponding to each secondary user includes one equivalent channel, and the plurality of secondary users includes N secondary users, where N is a positive integer greater than 1. For example, this situation corresponds to a scenario in which there is N GAA users and one RIS in the communication system.

As mentioned above, in a scenario where there are multiple GAA users in the communication system, the GAA users report the sensed data or sensing results to a fusion center FC (that is, the electronic apparatus 400 in the embodiment). The fusion center FC then fuses the sensing data or results from multiple GAA users by using a fusion algorithm, to judge an occupancy status of the sensed frequency band.

The fusion algorithm mainly includes data fusion and sensing decision fusion. The data fusion algorithm is generally performed with a manner of equal gain merging, that is, detection statistics calculated by multiple GAA users are directly summed and compared with a given detection threshold to obtain a final sensing result. A rule for the sensing decision fusion may roughly include the following three: logical AND, logical OR, and K-rank. The logical AND rule means to determine that a spectrum is occupied in a case where the GAA users all detect that the spectrum is occupied. The logical OR rule means to determine that a spectrum is occupied in a case where at least one GAA user detects that the spectrum is occupied. The K-rank rule means to determine that a spectrum is occupied in a case where at least K GAA users detect that the spectrum is occupied.

As an example, the processing unit 401 may be configured to determine the optimal reflection coefficient matrix corresponding to the one reconfigurable intelligent surface to be: a reflection coefficient matrix, based on which a sum of channel gain of N equivalent channels from the primary user to the N secondary users via the one reconfigurable intelligent surface is maximized. This situation corresponds to the manner of equal gain merging as described above.

As an example, the processing unit 401 may be configured to determine the optimal reflection coefficient matrix Φ* through the following equation:

$${Φ}^{*} = arg {max}_{Φ} {‖ {G}^{h} Φ f ‖}^{2}$$

where Φ represents a reflection coefficient matrix corresponding to the one reconfigurable intelligent surface,
f represents a mean value of channel coefficient of a channel between the one reconfigurable intelligent surface and the primary user, and gₙ represents a mean value of channel coefficient of a channel between the one reconfigurable intelligent surface and the n-th secondary user, where n is a positive integer from 1 to N,
G=[g₁, . . . , g_{N}] represents a vector including mean value of channel coefficients of channels between the one reconfigurable intelligent surface and the N secondary users,
∥G^{H}Φf∥² represents a sum of channel gain of N equivalent channels from the primary user to the N secondary users via the one reconfigurable intelligent surface,
H represents a transpose operation, and

$$arg {max}_{Φ} {‖ {G}^{h} Φ f ‖}^{2}$$

represents to traverse Φ and select Φ which maximizes |G^{H}Φf|² as the optimal reflection coefficient matrix Φ*.

As an example, each secondary user obtains f and gₙ measured at the RIS and feeds them back to the electronic apparatus 400. The electronic apparatus 400 calculates the optimal reflection coefficient matrix of the RIS according to the fusion rule of a collaborative spectrum sensing algorithm. For example, when applying the manner of equal gain merging in the data fusion method, the reflection coefficient matrix of the RIS may be adjusted to maximize the sum of gains of the N equivalent reflection channels of all the N secondary users, that is, the optimal reflection coefficient matrix of the RIS is calculated through

$${Φ}^{*} = arg {max}_{Φ} {‖ {G}^{H} Φ f ‖}^{2} .$$

As an example, the processing unit 401 may be configured to determine the optimal reflection coefficient matrix corresponding to the one reconfigurable intelligent surface to be: a reflection coefficient matrix, based on which a sum of channel gain of the one equivalent channel and a direct channel corresponding to a secondary user, whose sum of channel gain of the one equivalent channel and the direct channel is minimum among the N secondary users, is maximized. This situation corresponds to the fusion manner of logical AND. If the direct channel and the one equivalent channel corresponding thereto are called a combined channel, then the fusion manner of logical AND is to maximize channel gain of the combined channel of the secondary user with the weakest gain of the combined channel among all the secondary users.

As an example, the processing unit 401 may be configured to determine the optimal reflection coefficient matrix Φ* through the following equation:

$${Φ}^{*} = arg {max}_{Φ} {min}_{n} \{ E [ {\vert {d}_{n} \vert}^{2} ] + {\vert {g}_{n}^{H} Φ f \vert}^{2} \}$$

where Φ represents a reflection coefficient matrix corresponding to the one reconfigurable intelligent surface,
E[|dₙ|²] represents channel gain of a direct channel between the primary user and the n-th secondary user, where n is a positive integer from 1 to N,
f represents a mean value of channel coefficient of a channel between the one reconfigurable intelligent surface and the primary user, and gₙ represents a mean value of channel coefficient of a channel between the one reconfigurable intelligent surface and the n-th secondary user,

$${\vert {g}_{n}^{H} Φ f \vert}^{2}$$

represents channel gain of an equivalent channel from the primary user to the n-th secondary user via the one reconfigurable intelligent surface,
H represents a transpose operation, and

$$arg {max}_{Φ} {min}_{n} \{ E [ {\vert {d}_{n} \vert}^{2} ] + {\vert {g}_{n}^{H} Φ f \vert}^{2} \}$$

represents to traverse Φ and n, for a secondary user whose sum of channel gain of the one equivalent channel and a direct channel corresponding to the secondary user is minimum among the N secondary users, a Φ that maximizes the sum of channel gain of the one equivalent channel and the direct channel corresponding to the secondary user is determined as the optimal reflection coefficient matrix Φ*.

As an example, the processing unit 401 may be configured to determine the optimal reflection coefficient matrix corresponding to the one reconfigurable intelligent surface to be: a reflection coefficient matrix, based on which a sum of channel gain of the one equivalent channel and a direct channel corresponding to a secondary user, whose sum of channel gain of the one equivalent channel and the direct channel is maximum among the N secondary users, is maximized. This situation corresponds to the fusion manner of logical OR. The fusion manner of logical OR is to maximize channel gain of the combined channel of the secondary user with the strongest gain of the combined channel among all the secondary users.

As an example, the processing unit 401 may be configured to determine the optimal reflection coefficient matrix Φ* through the following equation:

$${Φ}^{*} arg {max}_{Φ} {max}_{n} \{ E [ {\vert {d}_{n} \vert}^{2} ] + {\vert {g}_{n}^{H} Φ f \vert}^{2} \}$$

where Φ represents a reflection coefficient matrix corresponding to the one reconfigurable intelligent surface,
E[|dₙ|²] represents channel gain of a direct channel between the primary user and the n-th secondary user, where n is a positive integer from 1 to N,
f represents a mean value of channel coefficient of a channel between the one reconfigurable intelligent surface and the primary user, and gₙ represents a mean value of channel coefficient of a channel between the one reconfigurable intelligent surface and the n-th secondary user,

$${\vert {g}_{n}^{H} Φ f \vert}^{2}$$

represents channel gain of an equivalent channel from the primary user to the n-th secondary user via the one reconfigurable intelligent surface,
H represents a transpose operation, and

$$arg {max}_{Φ} {min}_{n} \{ E [ {\vert {d}_{n} \vert}^{2} ] + {\vert {g}_{n}^{H} Φ f \vert}^{2} \}$$

represents to traverse Φ and n, for a secondary user whose sum of channel gain of the one equivalent channel and a direct channel corresponding to the secondary user is maximum among the N secondary users, a Φ that maximizes the sum of channel gain of the one equivalent channel and the direct channel corresponding to the secondary user is determined as the optimal reflection coefficient matrix Φ*.

As an example, the processing unit 401 may be configured to determine the optimal reflection coefficient matrix corresponding to the one reconfigurable intelligent surface to be: a reflection coefficient matrix, based on which a sum of channel gain of the one equivalent channel and a direct channel corresponding to a secondary user, whose sum of channel gain of the one equivalent channel and the direct channel is minimum in each subset containing K secondary users, is maximized, where K is less than or equal to N. This situation corresponds to the fusion manner of K-rank.

As an example, the processing unit 401 may be configured to determine the optimal reflection coefficient matrix Φ* through the following equation:

$${Φ}^{*} arg {max}_{Φ} f ( {Φ}^{i} )$$

where there has

$$f ( {Φ}^{i} ) = {max}_{{Φ}^{i}} {min}_{n ∈ {K}_{i}} \{ E [ {\vert {d}_{n} \vert}^{2} ] + {\vert {g}_{n}^{H} Φ f \vert}^{2} \} ,$$

where Φ represents a reflection coefficient matrix corresponding to the one reconfigurable intelligent surface,
Kᵢ represents the i-th subset containing K secondary users, where i is a positive integer greater than or equal to 1,
E[|dₙ|²] represents channel gain of a direct channel between the primary user and the n-th secondary user in Kᵢ, where n is a positive integer,
f represents a mean value of channel coefficient of a channel between the one reconfigurable intelligent surface and the primary user, and gₙ represents a mean value of channel coefficient of a channel between the one reconfigurable intelligent surface and the n-th secondary user in Kᵢ,

$${\vert {g}_{n}^{H} Φ f \vert}^{2}$$

represents channel gain of an equivalent channel from the primary user to the n-th secondary user in Kᵢ via the one reconfigurable intelligent surface,
H represents a transpose operation,
f(Φⁱ) represents to apply a reflection coefficient matrix Φⁱ, to maximize a sum of channel gain of the one equivalent channel and a direct channel corresponding to a secondary user, whose sum of channel gain of the one equivalent channel and a direct channel corresponding to the secondary user is minimum in Kᵢ, and

$${Φ}^{*} arg {max}_{Φ} f ( {Φ}^{i} )$$

represents that Φⁱ with which f(Φⁱ) is maximized is determined to be the optimal reflection coefficient matrix Φ*.

In the K-rank fusion manner, all K-based subsets of the set of N secondary users are obtained first, and then gain of the combined channel of the secondary user with the weakest gain of the combined channel among secondary users in each of the subsets is maximized. Here, f(Φⁱ) represents gain of a combined channel of a secondary user with the weakest gain of the combined channel in subset Kᵢ after the reflection coefficient matrix Φⁱ is applied. Finally, Φⁱ with which f(Φⁱ) is maximized is determined to be the optimal reflection coefficient matrix of the RIS.

As an example, the at least one reconfigurable intelligent surface includes L reconfigurable intelligent surfaces, and the at least one equivalent channel corresponding to each secondary user includes L equivalent channels, where L is a positive integer greater than 1, and the multiple secondary users includes N secondary users, where N is a positive integer greater than 1. This situation corresponds to a scenario in which there is N secondary users and L RISs in the communication system.

As an example, the processing unit 401 may be configured to determine respective optimal reflection coefficient matrices corresponding to the L reconfigurable intelligent surfaces to be: reflection coefficient matrices, based on which a sum of channel gain of N×L equivalent channels from the primary user to the N secondary users via the L reconfigurable intelligent surfaces is maximized. This situation corresponds to the manner of equal gain merging.

As an example, the processing unit 401 may be configured to determine the optimal reflection coefficient matrices

$${Φ}_{1}^{*} , … , {Φ}_{L}^{*}$$

of the L reconfigurable intelligent surfaces through the following equation:

$${Φ}_{1}^{*} , … , {Φ}_{L}^{*} = arg {max}_{{Φ}_{1}^{*} , … , {Φ}_{L}^{*}} {‖ {\sum }_{l = 1}^{L} {G}_{l}^{H} {Φ}_{l} {f}_{l} ‖}^{2}$$

where Φₗ represents a reflection coefficient matrix corresponding to the l-th reconfigurable intelligent surface, l is a positive integer from 1 to L,
fₗ represents a mean value of channel coefficient of a channel between the l-th reconfigurable intelligent surface and the primary user, and g_{l,n} represents a mean value of channel coefficient of a channel between the l-th reconfigurable intelligent surface and the n-th secondary user, where n is a positive integer from 1 to N,
Gₗ=[g_{l,1}, . . . , g_{l,N}] represents a vector including mean value of channel coefficients of channels from the l-th reconfigurable intelligent surface to the N secondary users,

$${‖ {\sum }_{l = 1}^{L} {G}_{l}^{H} {Φ}_{l} {f}_{l} ‖}^{2}$$

represents a sum of channel gain of N×L equivalent channels from the primary user to the N secondary users via the L reconfigurable intelligent surfaces,
H represents a transpose operation, and

$$arg {max}_{{Φ}_{1} , … , {Φ}_{L}} {‖ {\sum }_{l = 1}^{L} {G}_{l}^{H} {Φ}_{l} {f}_{l} ‖}^{2}$$

represents to traverse Φ₁, . . . , Φ_{L} and select Φ₁, . . . , Φ_{L} which maximize

$${‖ {\sum }_{l = 1}^{L} {G}_{l}^{H} {Φ}_{l} {f}_{l} ‖}^{2}$$

as the optimal reflection coefficient matrices

$${Φ}_{1}^{*} , … , {Φ}_{L}^{*} .$$

For example, each secondary user obtains fₗ and g_{l,n} measured at each RIS and feeds them back to the electronic apparatus 400. The electronic apparatus 400 may calculate the optimal reflection coefficient matrices of the RISs according to the fusion rule of a collaborative spectrum sensing algorithm. For example, when applying the manner of equal gain merging in the data fusion method, the reflection coefficient matrices of the RISs may be adjusted to maximize the sum of gains of an overall equivalent reflection channel of all the N secondary users (the overall equivalent reflection channel of respective secondary user is formed by L equivalent reflection channels between the secondary user and the primary user via the L RISs), that is, the optimal reflection coefficient matrices of the RISs are calculated through L RISs), that is, the optimal reflection coefficient matrices of the RISs are calculated through

$${Φ}_{1}^{*} , … , {Φ}_{L}^{*} = arg {max}_{{Φ}_{1} , … , {Φ}_{L}} {‖ {\sum }_{l = 1}^{L} {G}_{l}^{H} {Φ}_{l} {f}_{l} ‖}^{2} .$$

As an example, the processing unit 401 may be configured to determine respective optimal reflection coefficient matrices corresponding to the L reconfigurable intelligent surfaces to be: reflection coefficient matrices, based on which a sum of channel gain of the L equivalent channels and a direct channel corresponding to a secondary user, whose sum of channel gain of the L equivalent channels and the direct channel is minimum among the N secondary users, is maximized. This situation corresponds to the fusion manner of logical AND. If the direct channel and the L equivalent channels corresponding thereto between a secondary user and the primary user are called a combined channel, then the fusion manner of logical AND is to maximize channel gain of the combined channel of the secondary user with the weakest gain of the combined channel among all the secondary users.

As an example, the processing unit 401 may be configured to determine the optimal reflection coefficient matrices

$${Φ}_{1}^{*} , … , {Φ}_{L}^{*}$$

corresponding to the L reconfigurable intelligent surfaces through the following equation:

$${Φ}_{1}^{*} , … , {Φ}_{L}^{*} = arg {max}_{{Φ}_{1}^{*} , … , {Φ}_{L}^{*}} {min}_{n} \{ E [ {\vert {d}_{n} \vert}^{2} ] + {\vert {\sum }_{l = 1}^{L} {g}_{l , n}^{H} {Φ}_{l} {f}_{l} \vert}^{2} \}$$

where Φₗ represents a reflection coefficient matrix corresponding to the l-th reconfigurable intelligent surface, l is a positive integer from 1 to L,
E[|dₙ|²] represents channel gain of a direct channel between the primary user and the n-th secondary user, where n is a positive integer from 1 to N,
fₗ represents a mean value of channel coefficient of a channel between the l-th reconfigurable intelligent surface and the primary user, and g_{l,n} represents a mean value of channel coefficient of a channel between the l-th reconfigurable intelligent surface and the n-th secondary user,

$${\vert {\sum }_{l = 1}^{L} {g}_{l , n}^{H} {Φ}_{l} {f}_{l} \vert}^{2}$$

represents a sum of channel gain of L equivalent channels from the primary user to the n-th secondary user via the L reconfigurable intelligent surfaces,
H represents a transpose operation, and

$$arg {max}_{{Φ}_{1}^{*} , … , {Φ}_{L}^{*}} {min}_{n} \{ E [ {\vert {d}_{n} \vert}^{2} ] + {\vert {\sum }_{l = 1}^{L} {g}_{l , n}^{H} {Φ}_{l} {f}_{l} \vert}^{2} \}$$

represents to traverse Φ₁, . . . , Φ_{L} and n, for a secondary user whose sum of channel gain of the L equivalent channels and a direct channel corresponding to the secondary user is minimum among the N secondary users, Φ₁, . . . , Φ_{L} that maximize the sum of channel gain of the L equivalent channels and the direct channel corresponding to the secondary user is determined as the optimal reflection coefficient matrices

$${Φ}_{1}^{*} , … , {Φ}_{L}^{*} .$$

As an example, the processing unit 401 may be configured to determine respective optimal reflection coefficient matrices corresponding to the L reconfigurable intelligent surfaces to be: reflection coefficient matrices, based on which a sum of channel gain of the L equivalent channels and a direct channel corresponding to a secondary user, whose sum of channel gain of the L equivalent channels and the direct channel is maximum among the N secondary users, is maximized. This situation corresponds to the fusion manner of logical OR. The fusion manner of logical OR is to maximize gain of the combined channel of the secondary user with the strongest gain of the combined channel among all the secondary users.

As an example, the processing unit 401 may be configured to determine the optimal reflection coefficient matrices

$${Φ}_{1}^{*} , … , {Φ}_{L}^{*}$$

corresponding to the L reconfigurable intelligent surfaces through the following equation:

$${Φ}_{1}^{*} , … , {Φ}_{L}^{*} = arg {max}_{{Φ}_{1}^{*} , … , {Φ}_{L}^{*}} {min}_{n} \{ E [ {\vert {d}_{n} \vert}^{2} ] + {\vert {\sum }_{l = 1}^{L} {g}_{l , n}^{H} {Φ}_{l} {f}_{l} \vert}^{2} \}$$

where Φₗ represents a reflection coefficient matrix corresponding to the l-th reconfigurable intelligent surface, l is a positive integer from 1 to L,
E[|dₙ|²] represents channel gain of a direct channel between the primary user and the n-th secondary user, where n is a positive integer from 1 to N,
fₗ represents a mean value of channel coefficient of a channel between the l-th reconfigurable intelligent surface and the primary user, and g_{l,n} represents a mean value of channel coefficient of a channel between the l-th reconfigurable intelligent surface and the n-th secondary user,

$${\vert {\sum }_{l = 1}^{L} {g}_{l , n}^{H} {Φ}_{l} {f}_{l} \vert}^{2}$$

represents a sum of channel gain of L equivalent channels from the primary user to the n-th secondary user via the L reconfigurable intelligent surfaces,
H represents a transpose operation, and

$$arg {max}_{{Φ}_{1}^{*} , … , {Φ}_{L}^{*}} {min}_{n} \{ E [ {\vert {d}_{n} \vert}^{2} ] + {\vert {\sum }_{l = 1}^{L} {g}_{l , n}^{H} {Φ}_{l} {f}_{l} \vert}^{2} \}$$

represents to traverse Φ₁, . . . , Φ_{L} and n, for a secondary user whose sum of channel gain of the L equivalent channels and a direct channel corresponding to the secondary user is maximum among the N secondary users, Φ₁, . . . , Φ_{L} that maximize the sum of channel gain of the L equivalent channels and the direct channel corresponding to the secondary user is determined as the optimal reflection coefficient matrices

$${Φ}_{1}^{*} , … , {Φ}_{L}^{*} .$$

As an example, the processing unit 401 may be configured to determine respective optimal reflection coefficient matrices corresponding to the L reconfigurable intelligent surfaces to be: reflection coefficient matrices, based on which a sum of channel gain of the L equivalent channels and a direct channel corresponding to a secondary user, whose sum of channel gain of the L equivalent channels and the direct channel is minimum in each subset containing K secondary users, is maximized, where K is less than or equal to N. This situation corresponds to the fusion manner of K-rank.

As an example, the processing unit 401 may be configured to determine the optimal reflection coefficient matrices Φ₁*, . . . , Φ_{L}* of the L reconfigurable intelligent surfaces through the following equation:

$${Φ}_{1}^{*} , … , {Φ}_{L}^{*} = arg {max}_{{Φ}_{1}^{i} , … , {Φ}_{L}^{i}} f ( {Φ}_{1}^{i} , … , {Φ}_{L}^{i} )$$

where there has

$$f ( {Φ}_{1}^{i} , … , {Φ}_{L}^{i} ) = arg {max}_{{Φ}_{1}^{i} , … , {Φ}_{L}^{i}} {min}_{n ∈ {K}_{i}} \{ E [ {\vert {d}_{n} \vert}^{2} ] + {\vert {\sum }_{l = 1}^{L} {g}_{l , n}^{H} {Φ}_{l} {f}_{l} \vert}^{2} \} ,$$

where Φₗ represents a reflection coefficient matrix corresponding to the l-th reconfigurable intelligent surface, l is a positive integer from 1 to L,
Kᵢ represents the i-th subset containing K secondary users, where i is a positive integer greater than or equal to 1,
E[|dₙ|²] represents channel gain of a direct channel between the primary user and the n-th secondary user in Kᵢ, where n is a positive integer,
fₗ represents a mean value of channel coefficient of a channel between the l-th reconfigurable intelligent surface and the primary user, and g_{l,n} represents a mean value of channel coefficient of a channel between the l-th reconfigurable intelligent surface and the n-th secondary user in Kᵢ,

$${\vert {\sum }_{l = 1}^{L} {g}_{l , n}^{H} {Φ}_{l} {f}_{l} \vert}^{2}$$

represents a sum of channel gain of L equivalent channels from the primary user to the n-th secondary user in Kᵢ via the L reconfigurable intelligent surfaces,
H represents a transpose operation,

$$f ( {Φ}_{1}^{i} , … , {Φ}_{L}^{i} )$$

represents to apply a reflection coefficient matrix

$${Φ}_{1}^{i} , … , {Φ}_{L}^{i} ,$$

to maximize a sum of channel gain of the L equivalent channels and a direct channel corresponding to a secondary user, whose sum of channel gain of the L equivalent channels and a direct channel corresponding to the secondary user is minimum in Kᵢ, and

$${Φ}_{1}^{*} , … , {Φ}_{L}^{*} = arg {max}_{{Φ}_{1}^{i} , … , {Φ}_{L}^{j}} f ( {Φ}_{1}^{i} , … , {Φ}_{L}^{i} )$$

represents that

$${Φ}_{1}^{i} , … , {Φ}_{L}^{i}$$

with which

$$f ( {Φ}_{1}^{i} , … , {Φ}_{L}^{i} )$$

is maximized are determined to be the optimal reflection coefficient matrices

$${Φ}_{1}^{*} , … , {Φ}_{L}^{*}$$

As an example, in the K-rank fusion, all K-based subsets of the set of N secondary users are obtained first, and then gain of the combined channel of the secondary user with the weakest gain of the combined channel among secondary users in each of the subsets is maximized. Here,

$$f ( {Φ}_{1}^{i} , … , {Φ}_{L}^{i} )$$

represents gain of a combined channel of a secondary user with the weakest gain of the combined channel in subset Kᵢ after the reflection coefficient matrix

$${Φ}_{1}^{i} , … , {Φ}_{L}^{i}$$

is applied. Finally, a combination of reflection coefficient matrices with which

$$f ( {Φ}_{1}^{i} , … , {Φ}_{L}^{i} )$$

is maximized is determined to be the optimal reflection coefficient matrices of the RISs.

After the optimal reflection coefficient matrices of the RISs are determined, each control link of the RISs sets the reflection coefficient of each reflection unit accordingly.

In a case where there are multiple secondary users, a spectrum occupancy status of the primary user may be determined in the following two methods. In a first method, each secondary user may measure a strength of a received signal (sensing signal) received from the primary user and calculate detection statistics (for example, energy of the received signal), and then transmit the detection statistics to the electronic apparatus 400. The electronic apparatus 400 may apply a fusion algorithm to obtain a final spectrum occupancy status of the primary user. In a second approach, each secondary user may measure a strength of a received signal received from the primary user and calculate detection statistics (for example, energy of the received signal), and compare the detection statistics with a detection threshold to obtain a spectrum occupancy status of the primary user. Then, each secondary user transmits the sensed spectrum occupancy status to the electronic apparatus 400, and the electronic apparatus 400 may apply a fusion algorithm to obtain a final spectrum occupancy status of the primary user.

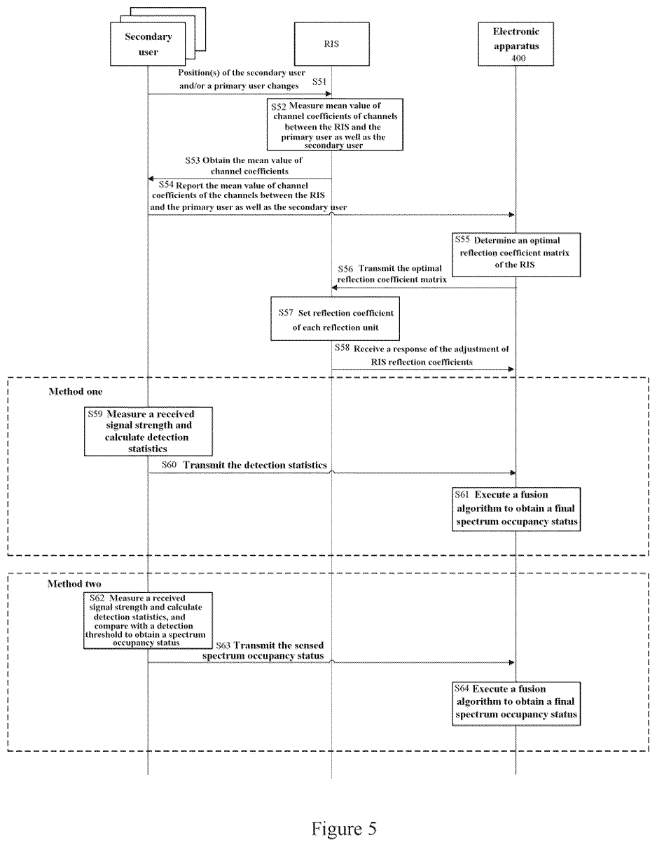

FIG. 5 is an information interaction diagram showing spectrum sensing performed by an electronic apparatus 400 via a reconfigurable intelligent surface according to an embodiment of the present disclosure. Although only one RIS is shown in FIG. 5, a situation having multiple RISs is possible.

In S51, assuming that a position(s) of a secondary user and/or a primary user changes, it is necessary to re-determine an optimal reflection coefficient matrix of the RIS.

In S52, the secondary user measures a mean value of channel coefficient of a channel between the RIS and the primary user and a mean value of channel coefficient of a channel between the RIS and the secondary user.

In S53, the secondary user obtains the mean value of channel coefficients.

In S54, the secondary user reports, to the electronic apparatus 400, the mean value of channel coefficients of the channels between the RIS and the primary user as well as the secondary user.

In S55, the electronic apparatus 400 determines an optimal reflection coefficient matrix of the RIS.

In S56, the electronic apparatus 400 transmits the optimal reflection coefficient matrix of the RIS to the RIS.

In S57, the RIS sets a reflection coefficient of each reflection unit according to the optimal reflection coefficient matrix.

In S58, the electronic apparatus 400 receives a response of the adjustment of RIS reflection coefficients.

S59 to S61 correspond to the above-mentioned first method of determining a spectrum occupancy status of the primary user.

In S59, the secondary user measures a strength of the received signal received from the primary user and calculates detection statistics.

In S60, the secondary user transmits the detection statistics to the electronic apparatus 400.

In S61, the electronic apparatus 400 executes a fusion algorithm to obtain a final spectrum occupancy status of the primary user.

S62 to S64 correspond to the above-mentioned second method of determining a spectrum occupancy status of the primary user.

In S62, the secondary user measures a strength of a received signal received from the primary user and calculates detection statistics, and compares the detection statistics with a detection threshold to obtain a spectrum occupancy status of the primary user.

In S63, the secondary user transmits the sensed spectrum occupancy status to the electronic apparatus 400.

In S64, the electronic apparatus 400 executes a fusion algorithm to obtain a final spectrum occupancy status of the primary user.

For convenience of explanation, both the first method and the second method are shown in the flow chart of FIG. 5. In practice, only one of the methods is implemented to determine a spectrum occupancy status of the primary user.

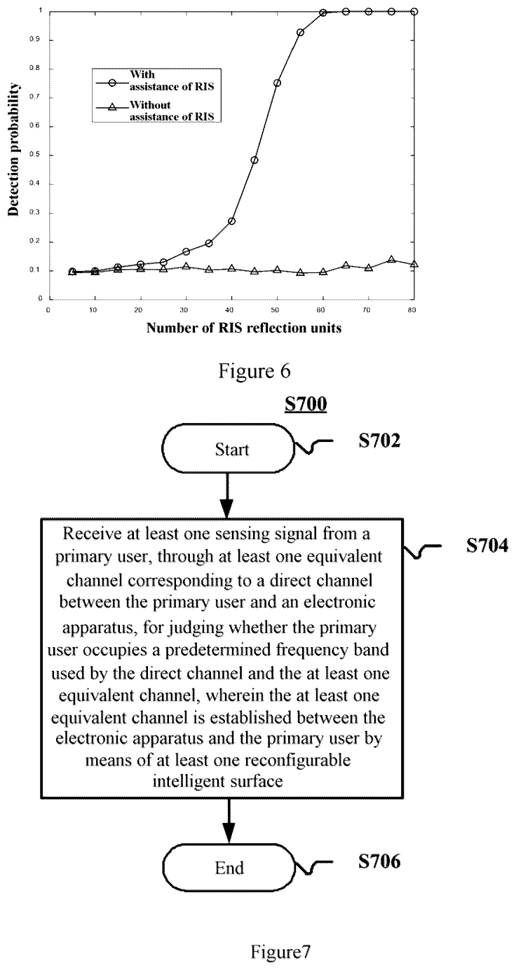

FIG. 6 is a diagram showing an effect of spectrum sensing using a reconfigurable intelligent surface according to an embodiment of the present disclosure.

In FIG. 6, the abscissa “Number of RIS reflection units” refers to the number of reflection units of RIS in single RIS-assisted spectrum sensing; and the ordinate “Detection probability” refers to a probability that a GAA user detects a PAL active status when a PAL user is active. This indicator is generally utilized to measure the performance of spectrum sensing. As can be seen from FIG. 6, compared with a situation without RIS assistance in the conventional technology, with the RIS assistance according to the embodiment of the present disclosure, the detection probability is greatly improved, the accuracy of spectrum sensing is improved, and the efficiency of spectrum sharing is improved.

In the description of the electronic apparatuses for wireless communications in the above embodiments, some processes or methods are further disclosed. Hereinafter, an overview of the methods is given without repeating some of details discussed above. It should be noted that although disclosed in the description of the electronic apparatuses for wireless communication, the methods do not necessarily adopt the components as described or be performed by those components. For example, an embodiment of the electronic apparatus for wireless communication may be implemented partially or entirely using hardware and/or firmware, while a method for wireless communication discussed below may be implemented entirely by a computer-executable program, although the method may employ the hardware and/or firmware for the electronic apparatus for wireless communication.

FIG. 7 shows a flow chart of a method S700 for wireless communications according to an embodiment of the present disclosure. The method S700 starts from step S702. In step S704, at least one sensing signal is received from a primary user, through at least one equivalent channel corresponding to a direct channel between the primary user and the electronic apparatus, for judging whether the primary user occupies a predetermined frequency band used by the direct channel and the at least one equivalent channel, wherein the at least one equivalent channel is established between the electronic apparatus and the primary user by means of at least one reconfigurable intelligent surface. The method S700 ends at step S706.

This method may be performed, for example, by the electronic apparatus 100 as described above. For specific details, reference may be made to the description of relevant processes of the electronic apparatus 100, which is not repeated here.

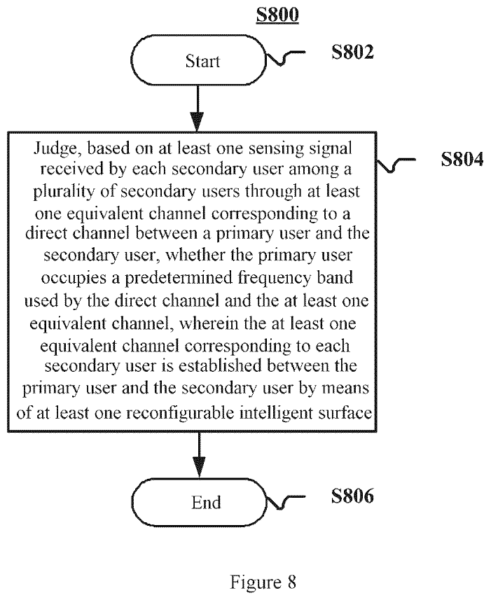

FIG. 8 shows a flow chart of a method S800 for wireless communications according to an embodiment of the present disclosure. The method S800 starts from step S802. In step S804, based on at least one sensing signal received by each secondary user among multiple secondary users through at least one equivalent channel corresponding to a direct channel between a primary user and the secondary user, it is judged whether the primary user occupies a predetermined frequency band used by the direct channel and the at least one equivalent channel, where the at least one equivalent channel corresponding to each secondary user is established between the primary user and the secondary user by means of at least one reconfigurable intelligent surface. The method S800 ends at step S806.

This method may be performed, for example, by the electronic apparatus 400 as described above. For specific details, reference may be made to the description of relevant processes of the electronic apparatus 400, which is not repeated here.

The technology of the present disclosure is applicable to various products.

The electronic apparatus 100 and the electronic apparatus 400 may be implemented as base stations. The base station may be implemented as any type of evolved Node B (eNB) or gNB (5G base station). An eNB includes, for example, a macro eNB and a small eNB. The small eNB may be an eNB covering a cell smaller than a macro cell, such as a pico eNB, a micro eNB, or a home (femto) eNB. A similar situation may apply to the gNB. Alternatively, the base station may be implemented as any other type of base station, such as a NodeB or a base transceiver station (BTS). The base station may include a body (which is also referred to as a base station device) configured to control wireless communications and one or more remote radio heads (RRHs) arranged at a different place from the body. In addition, various types of electronic apparatuses can all operate as base stations by temporarily or semi-persistently performing base station functions.

### Application Examples of Base Station

### First Application Example

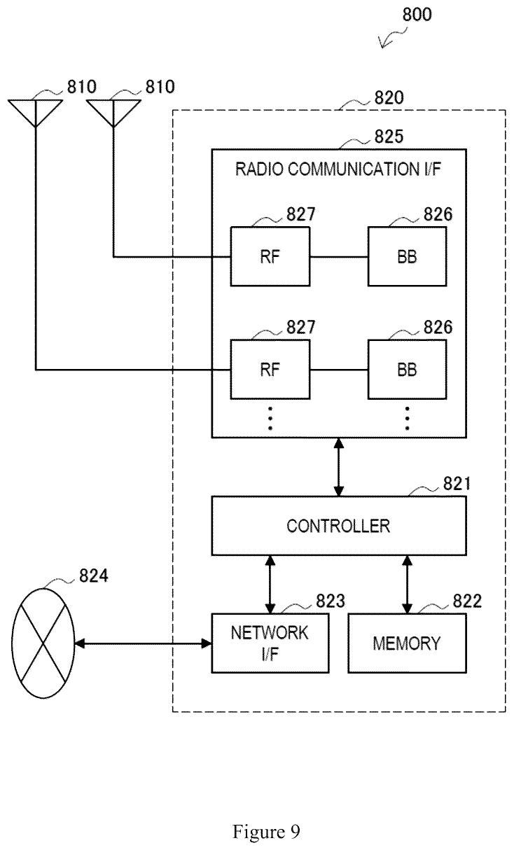

FIG. 9 is a block diagram showing a first example of a schematic configuration of an eNB or gNB to which the technology of the present disclosure is applicable. It should be noted that the following description is made taking an eNB as an example. The technology of the present disclosure is also applicable to a gNB. An eNB 800 includes one or more antennas 810 and a base station device 820. The base station device 820 and each of the antennas 810 may be connected to each other via a RF cable.

Each of the antennas 810 includes a single or multiple antenna elements (such as multiple antenna elements included in a multi-input multi-output (MIMO) antenna), and is used for the base station device 820 to transmit and receive wireless signals. As shown in FIG. 9, the eNB 800 may include multiple antennas 810. For example, the multiple antennas 810 may be compatible with multiple frequency bands used by the eNB 800. Although FIG. 9 shows an example in which the eNB 800 includes multiple antennas 810, the eNB 800 may include a single antenna 810.

The base station device 820 includes a controller 821, a memory 822, a network interface 823, and a radio communication interface 825.

The controller 821 may be, for example, a CPU or DSP, and operates various functions of a higher layer of the base station device 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have logical functions of performing control such as radio resource control, radio bearer control, mobility management, admission control, and scheduling. The control may be performed in conjunction with a nearby eNB or a core network node. The memory 822 includes an RAM and an ROM, and stores a program executed by the controller 821 and various types of control data (such as a terminal list, transmission power data, and scheduling data).

The network interface 823 is a communication interface for connecting the base station device 820 to a core network 824. The controller 821 may communicate with the core network node or another eNB via the network interface 823. In this case, the eNB 800 and the core network node or another eNB may be connected to each other through a logical interface (such as an S1 interface and an X2 interface). The network interface 823 may be a wired communication interface or a radio communication interface for a wireless backhaul line. In a case that the network interface 823 is a radio communication interface, the network interface 823 may use a higher frequency band for wireless communications than a frequency band used by the radio communication interface 825.

The radio communication interface 825 supports any cellular communication scheme (such as Long-Term Evolution (LTE) and LTE-Advanced), and provides wireless connection to a terminal in a cell of the eNB 800 via the antenna 810. The radio communication interface 825 may typically include, for example, a baseband (BB) processor 826 and an RF circuit 87. The BB processor 826 may perform, for example, coding/decoding, modulation/demodulation and multiplexing/de-multiplexing, and perform various types of signal processes of layers (for example, layer 1, media access control (MAC), radio link control (RLC) and packet data convergence protocol (PDCP)). Instead of the controller 821, the BB processor 826 may have a part or all of the above-mentioned logical functions. The BB processor 826 may be a memory storing a communication control program, or a module including a processor and a related circuit configured to execute the program. Updating the program may change the functions of the BB processor 826. The module may be a card or blade inserted into a slot of the base station device 820. Alternatively, the module may be a chip mounted on the card or blade. In addition, the RF circuit 87 may include, for example, a mixer, a filter and an amplifier, and transmit and receive a wireless signal via the antenna 810.

As shown in FIG. 9, the radio communication interface 825 may include multiple BB processors 826. For example, the multiple BB processors 826 may be compatible with multiple frequency bands used by the eNB 800. As shown in FIG. 9, the radio communication interface 825 may include multiple RF circuits 87. For example, the multiple RF circuits 87 may be compatible with multiple antenna elements. Although FIG. 9 shows an example in which the radio communication interface 825 includes multiple BB processors 826 and multiple RF circuits 87, the radio communication interface 825 may include a single BB processor 826 or a single RF circuit 87.

In a case where the electronic apparatus 100 and the electronic apparatus 400 are implemented as the eNB 800 of the type shown in FIG. 9, their transceivers may be implemented by the radio communication interface 825. At least a part of the functions may be implemented by the controller 821. For example, the controller 821 may perform spectrum sensing by means of the reconfigurable intelligent surface by performing functions of the units in the electronic apparatus 100 and the electronic apparatus 400.

### Second Application Example

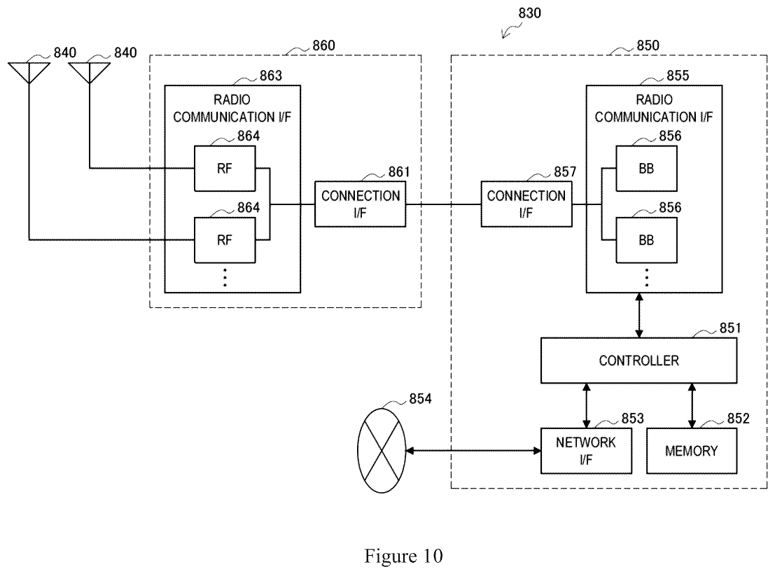

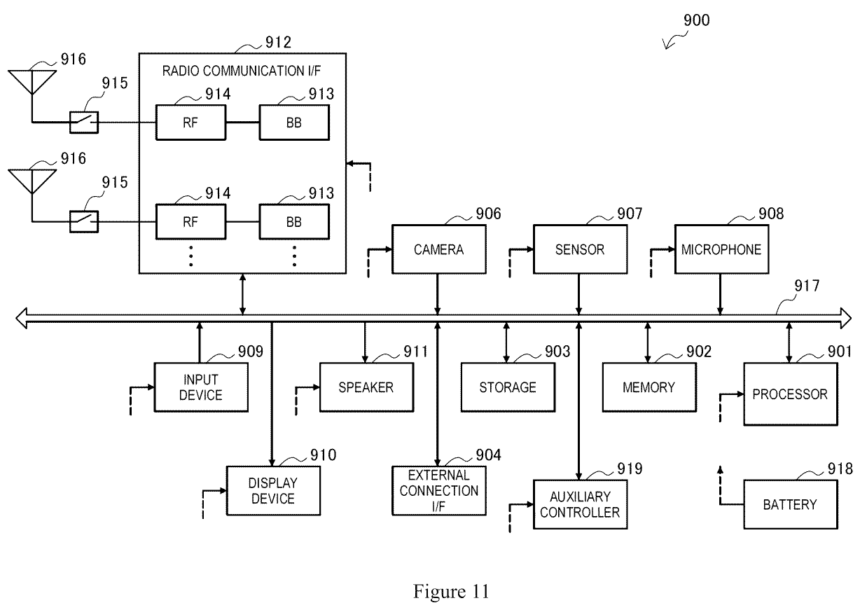

FIG. 10 is a block diagram showing a second example of a schematic configuration of an eNB or gNB to which the technology of the present disclosure is applicable. It should be noted that the following description is made taking the eNB as an example. The technology of the present disclosure is also applicable to the gNB. An eNB 830 includes a single or multiple antennas 840, a base station device 850 and an RRH 860. The RRH 860 and each of the antennas 840 may be connected to each other via an RF cable. The base station device 850 and the RRH 860 may be connected to each other via a high-speed line such as an optical fiber cable.

Each of the antennas 840 includes a single or multiple antenna elements (such as multiple antenna elements included in a MIMO antenna), and is used for the RRH 860 to transmit and receive a wireless signal. As shown in FIG. 10, the eNB 830 may include multiple antennas 840. For example, the multiple antennas 840 may be compatible with multiple frequency bands used by the eNB 830. Although FIG. 10 shows an example in which the eNB 830 includes multiple antennas 840, the eNB 830 may include a single antenna 840.

The base station device 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 9.

The radio communication interface 855 supports any cellular communication scheme (such as LTE and LTE-advanced), and provides wireless communications to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 9, except that the BB processor 856 is connected to an RF circuit 864 of the RRH 860 via the connection interface 857. As shown in FIG. 10, the radio communication interface 855 may include multiple BB processors 856. For example, the multiple BB processors 856 may be compatible with multiple frequency bands used by the eNB 830. Although FIG. 10 shows an example in which the radio communication interface 855 includes multiple BB processors 856, the radio communication interface 855 may include a single BB processor 856.

The connection interface 857 is an interface for connecting the base station device 850 (the radio communication interface 855) to the RRH 860. The connection interface 857 may be a communication module for communication in the above-described high-speed line that connects the base station device 850 (the radio communication interface 855) to the RRH 860.

The RRH 860 includes a connection interface 861 and a radio communication interface 863.

The connection interface 861 is an interface for connecting the RRH 860 (the radio communication interface 863) to the base station device 850. The connection interface 861 may be a communication module for communication in the above-mentioned high-speed line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmit and receive wireless signals via the antenna 840. As shown in FIG. 10, the radio communication interface 863 may include multiple RF circuits 864. For example, the multiple RF circuits 864 may support multiple antenna elements. Although FIG. 10 shows an example in which the radio communication interface 863 includes multiple RF circuits 864, the radio communication interface 863 may include a single RF circuit 864.

In a case where the electronic apparatus 100 and the electronic apparatus 400 are implemented as the eNB 830 as shown in FIG. 10, their transceivers may be implemented by the radio communication interface 855. At least a part of the functions may be implemented by the controller 851. For example, the controller 851 may perform spectrum sensing by means of the reconfigurable intelligent surface by performing functions of the units in the electronic apparatus 100 and the electronic apparatus 400.

### Application Example of User Equipment

### First Application Example

FIG. 11 is a block diagram showing an example of a schematic configuration of a smart phone 900 to which the technology of the present disclosure is applicable. The smart phone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on chip (SoC), and controls functions of the application layer and other layers of the smart phone 900. The memory 902 includes an RAM and an ROM, and stores data and programs executed by the processor 901. The storage 903 may include a storage medium, such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyroscope sensor, a geomagnetic sensor, and an acceleration sensor. The microphone 908 converts sound inputted to the smart phone 900 into an audio signal. The input device 909 includes, for example, a touch sensor configured to detect a touch on a screen of the display device 910, a keypad, a keyboard, a button, or a switch, and receives an operation or information inputted from a user. The display device 910 includes a screen, such as a liquid crystal display (LCD) or an organic light emitting diode (OLED) display, and displays an output image of the smart phone 900. The speaker 911 converts the audio signal outputted from the smart phone 900 into sound.

The radio communication interface 912 supports any cellular communication scheme (such as LTE and LTE-Advanced), and performs wireless communications. The radio communication interface 912 may generally include, for example, a BB processor 913 and an RF circuit 914. The BB processor 913 may perform, for example, encoding/decoding, modulation/demodulation, and multiplexing/demultiplexing, and perform various types of signal processing for wireless communications. In addition, the RF circuit 914 may include, for example, a mixer, a filter and an amplifier, and transmit and receive a wireless signal via the antenna 916. It should be noted that, although the figure shows a situation where one RF link is connected to one antenna, this is only illustrative, and a situation where one RF link is connected to multiple antennas through multiple phase shifters is also possible. The radio communication interface 912 may be a chip module on which the BB processor 913 and the RF circuit 914 are integrated. As shown in FIG. 11, the radio communication interface 912 may include multiple BB processors 913 and multiple RF circuits 914. Although FIG. 11 shows an example in which the radio communication interface 912 includes multiple BB processors 913 and multiple RF circuits 914, the radio communication interface 912 may include a single BB processor 913 or a single RF circuit 914.

In addition to the cellular communication scheme, the radio communication interface 912 may support another type of wireless communication scheme, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits (for example, circuits for different wireless communication schemes) included in the radio communication interface 912.

Each of the antennas 916 includes a single or multiple antenna elements (such as multiple antenna elements included in a MIMO antenna), and is configured for the radio communication interface 912 to transmit and receive wireless signals. As shown in FIG. 11, the smart phone 900 may include multiple antennas 916. Although FIG. 11 shows an example in which the smart phone 900 includes multiple antennas 916, the smart phone 900 may include a single antenna 916.

In addition, the smart phone 900 may include antenna(s) 916 for each wireless communication scheme. In this case, the antenna switches 915 may be omitted from the configuration of the smart phone 900.

The processor 901, the memory 902, the storage 903, the external connection interface 904, the camera 906, the sensor 907, the microphone 908, the input device 909, the display device 910, the speaker 911, the radio communication interface 912, and the auxiliary controller 919 are connected to each other via the bus 917. The battery 918 supplies power to each block of the smart phone 900 as shown in FIG. 11 via a feeder line. The feeder line is partially shown as a dashed line in the figure. The auxiliary controller 919 operates the least necessary function of the smart phone 900 in a sleep mode, for example.

### Second Application Example

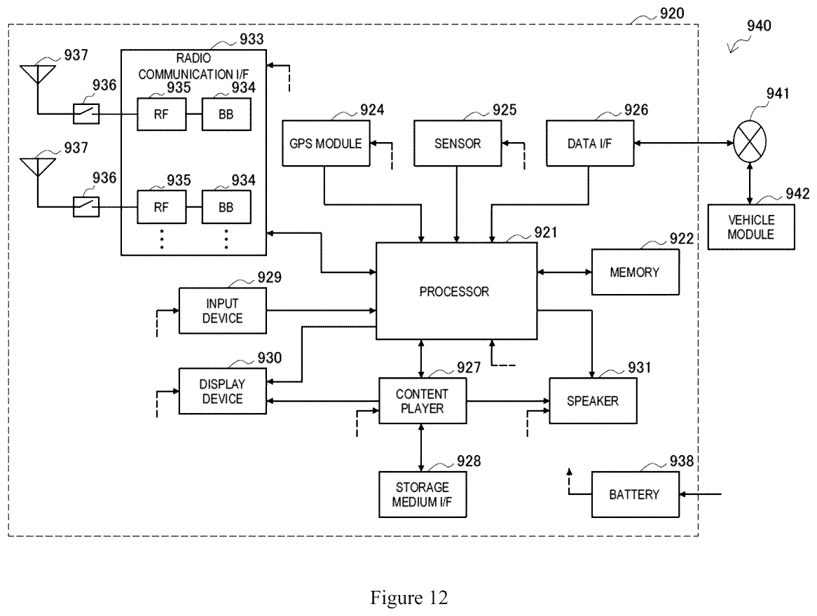

FIG. 12 is a block diagram showing an example of a schematic configuration of an automobile navigation device 920 to which the technology of the present disclosure is applicable. The automobile navigation device 920 includes a processor 921, a memory 922, a global positioning system (GPS) module 924, a sensor 925, a data interface 926, a content player 97, a storage medium interface 928, an input device 99, a display device 930, a speaker 931, a radio communication interface 913, one or more antenna switches 936, one or more antennas 937, and a battery 938.

The processor 921 may be, for example, a CPU or SoC, and controls the navigation function and other functions of the automobile navigation device 920. The memory 922 includes an RAM and an ROM, and stores data and programs executed by the processor 921.

The GPS module 924 measures a position (such as latitude, longitude, and altitude) of the automobile navigation device 920 based on a GPS signal received from a GPS satellite. The sensor 925 may include a group of sensors, such as a gyroscope sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 97 reproduces content stored in a storage medium (such as a CD and a DVD) inserted into the storage medium interface 928. The input device 99 includes, for example, a touch sensor configured to detect a touch on a screen of the display device 930, a button, or a switch, and receives an operation or information inputted from a user. The display device 930 includes a screen such as an LCD or OLED display, and displays an image of a navigation function or reproduced content. The speaker 931 outputs a sound of the navigation function or reproduced content.

The radio communication interface 913 supports any cellular communication scheme (such as LTE and LTE-Advanced), and performs wireless communications. The radio communication interface 913 may generally include, for example, a BB processor 934 and an RF circuit 935. The BB processor 934 may perform, for example, encoding/decoding, modulation/demodulation, and multiplexing/demultiplexing, and perform various types of signal processing for wireless communications. In addition, the RF circuit 935 may include, for example, a mixer, a filter and an amplifier, and transmit and receive a wireless signal via the antenna 937. The radio communication interface 913 may be a chip module on which the BB processor 934 and the RF circuit 935 are integrated. As shown in FIG. 12, the radio communication interface 913 may include multiple BB processors 934 and multiple RF circuits 935. Although FIG. 12 shows an example in which the radio communication interface 913 includes multiple BB processors 934 and multiple RF circuits 935, the radio communication interface 913 may include a single BB processor 934 or a single RF circuit 935.

In addition to the cellular communication scheme, the radio communication interface 913 may support another type of wireless communication scheme, such as a short-range wireless communication scheme, a near field communication scheme, or a wireless LAN scheme. In this case, the radio communication interface 913 may include a BB processor 934 and an RF circuit 935 for each wireless communication scheme.

Each of the antenna switches 936 switches a connection destination of the antenna 937 among multiple circuits (such as circuits for different wireless communication schemes) included in the radio communication interface 913.

Each of the antennas 937 includes a single or multiple antenna elements (such as multiple antenna elements included in a MIMO antenna), and is configured for the radio communication interface 913 to transmit and receive wireless signals. As shown in FIG. 12, the automobile navigation device 920 may include multiple antennas 937. Although FIG. 12 shows an example in which the automobile navigation device 920 includes multiple antennas 937, the automobile navigation device 920 may include a single antenna 937.

In addition, the automobile navigation device 920 may include antenna(s) 937 for each wireless communication scheme. In this case, the antenna switches 936 may be omitted from the configuration of the automobile navigation device 920.

The battery 938 supplies power to blocks of the automobile navigation device 920 shown in FIG. 12 via a feeder line. The feeder line is partially shown as a dashed line in the figure. The battery 938 accumulates electric power supplied from the vehicle.

The technology of the present disclosure may be implemented as an in-vehicle system (or vehicle) 940 including the vehicle navigation device 920, an in-vehicle network 941, and one or more blocks of vehicle modules 942. The vehicle modules 942 generate vehicle data (such as vehicle speed, engine speed, and failure information), and outputs the generated data to the in-vehicle network 941.

Basic principles of the present disclosure are described above in conjunction with the specific embodiments. However, it should be noted that those skilled in the art can understand that all or any of steps or components of the methods and apparatuses of the present disclosure may be implemented in any computing device (including processors, storage media, and the like) or a network of computing devices in a form of hardware, firmware, software or a combination thereof. Such implementation can be realized by those skilled in the art after reading the description of the present disclosure, by utilizing basic knowledge of circuit design or basic programming skills.

Moreover, a program product storing machine-readable instruction codes is further provided according to an embodiment of the present disclosure. The instruction codes, when read and executed by a machine, may implement the method according to any of the embodiments of the present disclosure.

Accordingly, a storage medium for carrying the program product storing the machine-readable instruction codes is further included in the present disclosure. The storage medium includes, but is not limited to, a floppy disk, an optical disk, a magneto-optical disk, a storage card, a memory stick, and the like.

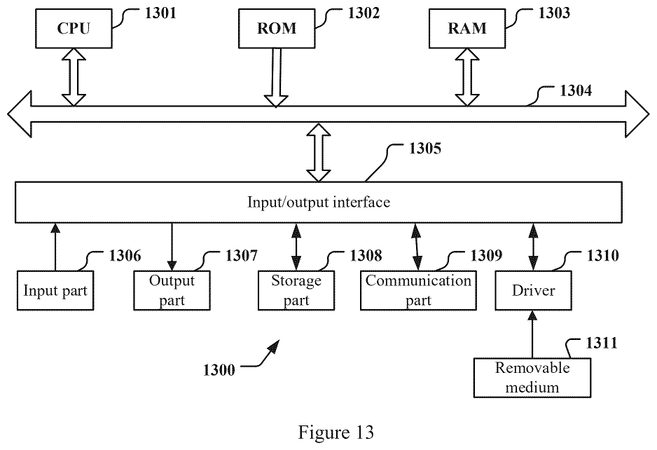

In a case of implementing the embodiments of the present disclosure in software or firmware, the program consisting of the software is mounted to a computer with a dedicated hardware structure (such as a general-purpose computer 1300 as shown in FIG. 13) from the storage medium or network. The computer, when mounted with various programs, performs various functions.

In FIG. 13, a central processing unit (CPU) 1301 executes various processes according to a program stored in a read-only memory (ROM) 1302 or a program loaded from a storage part 1308 to a random-access memory (RAM) 1303. In the RAM 1303, data required for the CPU 1301 to perform various processes or the like is stored as necessary. The CPU 1301, the ROM 1302 and the RAM 1303 are connected to each other via a bus 1304. An input/output interface 1305 is connected to the bus 1304.

The following components are connected to the input/output interface 1305: an input part 1306 (including a keyboard, a mouse, and the like), an output part 1307 (including a display, such as a cathode ray tube (CRT) and a liquid crystal display (LCD), a loudspeaker, and the like), a storage part 1308 (including a hard disk and the like), and a communication part 1309 (including a network interface card, such as a LAN card, and a modem). The communication part 1309 performs communication processing via a network, such as the Internet. A driver 1310 may be connected to the input/output interface 1305 as needed. A removable medium 1311, such as a magnetic disk, an optical disk, a magnetic optical disk, and a semiconductor memory, is mounted to the driver 1310 as required, so that a computer program read therefrom is mounted to the storage part 1308 as required.

In a case that the above processes are implemented by software, the program consisting the software is mounted from a network, such as the Internet, or from a storage medium, such as the removable medium 1311.

Those skilled in the art should understood that, the storage medium is not limited to the removable medium 1311, as shown in FIG. 13, which stores a program and is distributed separately from the device so as to provide the program for a user. Examples of the removable medium 1311 includes a magnetic disk (including a floppy disk (registered trademark)), an optical disk (including a compact disk read-only memory (CD-ROM) and a Digital Versatile Disk (DVD)), a magneto-optical disk (including a mini disk (MD) (registered trademark)), and a semiconductor memory. Alternatively, the storage medium may be the ROM 1302, the hard disk contained in the storage part 1308, or the like. The storage medium stores a program and is distributed to the user along with an apparatus in which the storage medium is incorporated.

It should be further noted that components or steps in the apparatus, method and system of the present disclosure can be decomposed and/or recombined. Such decomposition and/or recombination should be considered equivalents of the present disclosure. Furthermore, steps for executing the above processes may naturally be executed in a chronological order as described, but do not necessarily need to be executed in the chronological order. Certain steps may be performed in parallel with or independently of each other.

Finally, it should be noted that terms “include”, “comprise” or any other variants are intended to be non-exclusive. Therefore, a process, method, article or device including a series of elements includes not only the elements but also other elements that are not enumerated, or further includes elements inherent to the process, method, article or device. In addition, unless expressively limited otherwise, the statement “comprising (including) a(n) . . . ” does not exclude existence of other similar elements in the process, method, article or device.

Although the embodiments of the present disclosure are described in detail above with reference to the accompanying drawings, it should be understood that the embodiments are only for illustrating the present disclosure and do not constitute a limitation to the present disclosure. For those skilled in the art, various modifications and changes can be made to the embodiments without departing from the spirit and scope of the present disclosure. Therefore, the scope of the present disclosure is limited by only the appended claims and equivalents thereof.

The present technology may be implemented as the following solutions.
Solution 1. An electronic apparatus for wireless communications, comprising:
processing circuitry configured to:
receive at least one sensing signal from a primary user, through at least one equivalent channel corresponding to a direct channel between the primary user and the electronic apparatus, for judging whether the primary user occupies a predetermined frequency band used by the direct channel and the at least one equivalent channel, wherein the at least one equivalent channel is established between the electronic apparatus and the primary user by means of at least one reconfigurable intelligent surface.
Solution 2. The electronic apparatus according to solution 1, wherein
reflection coefficient(s) of a reflection unit of each of the at least one reconfigurable intelligent surface is set based on an optimal reflection coefficient matrix corresponding to the reconfigurable intelligent surface, wherein the optimal reflection coefficient matrix is determined so as to maximize channel gain of channel(s) obtained based on the at least one equivalent channel.
Solution 3. The electronic apparatus according to solution 2, wherein in a case where a change in a communication system to which the electronic apparatus belongs satisfies predetermined conditions, the optimal reflection coefficient matrix is re-determined.
Solution 4. The electronic apparatus according to solution 3, wherein
the predetermined conditions include an access and/or exit of equipment in the communication system, and/or
the predetermined condition includes change(s) in position(s) of the electronic apparatus and/or the primary user.
Solution 5. The electronic apparatus according to any one of solutions 2 to 4, wherein
the processing circuitry is configured to determine, based on channel statistical information of channels between the at least one reconfigurable intelligent surface and the primary user as well as the electronic apparatus, an optimal reflection coefficient matrix respectively corresponding to the at least one reconfigurable intelligent surface.
Solution 6. The electronic apparatus according to solution 5, wherein
the at least one reconfigurable intelligent surface comprises one reconfigurable intelligent surface, and
the processing circuitry is configured to determine the optimal reflection coefficient matrix to be: a reflection coefficient matrix, based on which channel gain of an equivalent channel from the primary user to the electronic apparatus via the one reconfigurable intelligent surface is maximized.
Solution 7. The electronic apparatus according to solution 6, wherein the processing circuitry is configured to determine the optimal reflection coefficient matrix Φ* through the following equation:

$${Φ}^{*} = arg {max}_{Φ} {\vert {g}^{H} Φ f \vert}^{2}$$

where Φ represents a reflection coefficient matrix corresponding to the one reconfigurable intelligent surface,
f represents a mean value of channel coefficient of a channel between the one reconfigurable intelligent surface and the primary user, and g represents a mean value of channel coefficient of a channel between the one reconfigurable intelligent surface and the electronic apparatus,
   |g^{H}Φf|² represents channel gain of an equivalent channel from the primary user to the electronic apparatus via the one reconfigurable intelligent surface,
H represents a transpose operation, and

$$arg {max}_{Φ} {\vert {g}^{H} Φ f \vert}^{2}$$

represents to traverse Φ and select Φ φwhich maximizes |g^{H}Φf|² as the optimal reflection coefficient matrix Φ*.
Solution 8. The electronic apparatus according to solution 5, wherein
the at least one reconfigurable intelligent surface comprises L reconfigurable intelligent surfaces, and the at least one equivalent channel comprises L equivalent channels, where L is a positive integer greater than 1, and
the processing circuitry is configured to determine respective optimal reflection coefficient matrices corresponding to the L reconfigurable intelligent surfaces to be: reflection coefficient matrices, based on which channel gain of a combined channel formed by the L equivalent channels from the primary user to the electronic apparatus via the L reconfigurable intelligent surfaces is maximized.
Solution 9. The electronic apparatus according to solution 8, wherein the processing circuitry is configured to determine the optimal reflection coefficient matrices

$${Φ}_{1}^{*} , … , {Φ}_{L}^{*}$$

corresponding to the L reconfigurable intelligent surfaces through the following equation:

$${Φ}_{1}^{*} , … , {Φ}_{L}^{*} = arg {max}_{{Φ}_{1} , … , {Φ}_{L}} {\vert {\sum }_{l = 1}^{L} {g}_{l}^{H} {Φ}_{l} {f}_{l} \vert}^{2}$$

where l represents a positive integer from 1 to L,
Φₗ represents a reflection coefficient matrix corresponding to the l-th reconfigurable intelligent surface,
fₗ represents a mean value of channel coefficient of a channel between the l-th reconfigurable intelligent surface and the primary user, and gₗ represents a mean value of channel coefficient of a channel between the l-th reconfigurable intelligent surface and the electronic apparatus,

$${\vert {\sum }_{l = 1}^{L} {g}_{l}^{H} {Φ}_{l} {f}_{l} \vert}^{2}$$

represents channel gain of a combined channel formed by the L equivalent channels from the primary user to the electronic apparatus via the L reconfigurable intelligent surfaces,
H represents a transpose operation, and

$$arg {max}_{{Φ}_{1} , … , {Φ}_{L}} {\vert {\sum }_{l = 1}^{L} {g}_{l}^{H} {Φ}_{l} {f}_{l} \vert}^{2}$$

represents to traverse Φ₁, . . . , Φ_{L} and select Φ₁, . . . , Φ_{L} which maximize

$${\vert {\sum }_{l = 1}^{L} {g}_{l}^{H} {Φ}_{l} {f}_{l} \vert}^{2}$$

as the optimal reflection coefficient matrices

$${Φ}_{1}^{*} , … , {Φ}_{L}^{*} .$$

Solution 10. The electronic apparatus according to any one of solutions 1 to 9, wherein the processing circuitry is configured to: compare the calculated statistics about the at least one sensing signal with a predetermined threshold, to determine whether the primary user occupies the predetermined frequency band.
Solution 11. The electronic apparatus according to any one of solutions 2 to 4, wherein
the processing circuitry is configured to transmit channel statistical information of channels between the at least one reconfigurable intelligent surface and the primary user as well as the electronic apparatus to a fusion center, for the fusion center to determine the optimal reflection coefficient matrix based on the channel statistical information and channel statistical information received from other electronic apparatus.
Solution 12. The electronic apparatus according to solution 11, wherein the processing circuitry is configured to: transmit the calculated statistics about the at least one sensing signal to the fusion center, for the fusion center to determine whether the primary user occupies the predetermined frequency band.
Solution 13. An electronic apparatus for wireless communications, comprising:
processing circuitry configured to:
judge, based on at least one sensing signal received by each secondary user among a plurality of secondary users through at least one equivalent channel corresponding to a direct channel between a primary user and the secondary user, whether the primary user occupies a predetermined frequency band used by the direct channel and the at least one equivalent channel,
wherein the at least one equivalent channel corresponding to each secondary user is established between the primary user and the secondary user by means of at least one reconfigurable intelligent surface.
Solution 14. The electronic apparatus according to solution 13, wherein
reflection coefficient(s) of a reflection unit of each of the at least one reconfigurable intelligent surface is set based on an optimal reflection coefficient matrix corresponding to the reconfigurable intelligent surface, wherein the optimal reflection coefficient matrix is determined so as to maximize channel gain of channel(s) obtained based on the at least one equivalent channel.
Solution 15. The electronic apparatus according to solution 14, wherein in a case where a change in a communication system to which the primary user and the plurality of secondary users belongs satisfy predetermined conditions, the optimal reflection coefficient matrix is re-determined.
Solution 16. The electronic apparatus according to solution 15, wherein
the predetermined conditions include an access and/or exit of equipment in the communication system, and/or
the predetermined condition includes change(s) in position(s) of the primary user and/or at least one secondary user in the plurality of secondary user.
Solution 17. The electronic apparatus according to any one of solutions 13 to 16, wherein
the processing circuitry is configured to determine, based on channel statistical information of channels between the at least one reconfigurable intelligent surface and the primary user as well as each secondary user among the plurality of secondary users obtained from the secondary user, an optimal reflection coefficient matrix respectively corresponding to the at least one reconfigurable intelligent surface.
Solution 18. The electronic apparatus according to solution 17, wherein
the at least one reconfigurable intelligent surface comprises one reconfigurable intelligent surface, and the at least one equivalent channel corresponding to each secondary user comprises one equivalent channel, and
the plurality of secondary users comprises N secondary users, where N is a positive integer greater than 1.
Solution 19. The electronic apparatus according to solution 18, wherein the processing circuitry is configured to determine the optimal reflection coefficient matrix corresponding to the one reconfigurable intelligent surface to be: a reflection coefficient matrix, based on which a sum of channel gain of N equivalent channels from the primary user to the N secondary users via the one reconfigurable intelligent surface is maximized.
Solution 20. The electronic apparatus according to solution 19, wherein the processing circuitry is configured to determine the optimal reflection coefficient matrix Φ* through the following equation:

$${Φ}^{*} = arg {max}_{Φ} {‖ {G}^{H} Φ f ‖}^{2}$$

where Φ represents a reflection coefficient matrix corresponding to the one reconfigurable intelligent surface,
f represents a mean value of channel coefficient of a channel between the one reconfigurable intelligent surface and the primary user, and gₙ represents a mean value of channel coefficient of a channel between the one reconfigurable intelligent surface and the n-th secondary user, where n is a positive integer from 1 to N,
G=[g₁, . . . , g_{N}] represents a vector including mean value of channel coefficients of channels between the one reconfigurable intelligent surface and the N secondary users,
∥G^{H}Φf∥² represents a sum of channel gain of N equivalent channels from the primary user to the N secondary users via the one reconfigurable intelligent surface,
H represents a transpose operation, and

$$arg {max}_{Φ} {‖ {G}^{H} Φ f ‖}^{2}$$

represents to traverse Φ and select Φ which maximizes ∥G^{H}Φf∥² as the optimal reflection coefficient matrix Φ*.
Solution 21. The electronic apparatus according to solution 18, wherein
the processing circuitry is configured to determine the optimal reflection coefficient matrix corresponding to the one reconfigurable intelligent surface to be: a reflection coefficient matrix, based on which a sum of channel gain of the one equivalent channel and a direct channel corresponding to a secondary user, whose sum of channel gain of the one equivalent channel and the direct channel is minimum among the N secondary users, is maximized.
Solution 22. The electronic apparatus according to solution 21, wherein the processing circuitry is configured to determine the optimal reflection coefficient matrix Φ* through the following equation:

$${Φ}^{*} = arg {max}_{Φ} {min}_{n} \{ E [ {\vert {d}_{n} \vert}^{2} ] + {\vert {g}_{n}^{H} Φ f \vert}^{2} \}$$

where Φ represents a reflection coefficient matrix corresponding to the one reconfigurable intelligent surface,
E[|dₙ|²] represents channel gain of a direct channel between the primary user and the n-th secondary user, where n is a positive integer from 1 to N,
f represents a mean value of channel coefficient of a channel between the one reconfigurable intelligent surface and the primary user, and gₙ represents a mean value of channel coefficient of a channel between the one reconfigurable intelligent surface and the n-th secondary user,

$${\vert {g}_{n}^{H} Φ f \vert}^{2}$$

represents channel gain of an equivalent channel from the primary user to the n-th secondary user via the one reconfigurable intelligent surface,
H represents a transpose operation, and

$$arg {max}_{Φ} {min}_{n} \{ E [ {\vert {d}_{n} \vert}^{2} ] + {\vert {g}_{n}^{H} Φ f \vert}^{2} \}$$

represents to traverse Φ and n, for a secondary user whose sum of channel gain of the one equivalent channel and a direct channel corresponding to the secondary user is minimum among the N secondary users, a Φ that maximizes the sum of channel gain of the one equivalent channel and the direct channel corresponding to the secondary user is determined as the optimal reflection coefficient matrix Φ*.
Solution 23. The electronic apparatus according to solution 18, wherein
the processing circuitry is configured to determine the optimal reflection coefficient matrix corresponding to the one reconfigurable intelligent surface to be: a reflection coefficient matrix, based on which a sum of channel gain of the one equivalent channel and a direct channel corresponding to a secondary user, whose sum of channel gain of the one equivalent channel and the direct channel is maximum among the N secondary users, is maximized.
Solution 24. The electronic apparatus according to solution 23, wherein the processing circuitry is configured to determine the optimal reflection coefficient matrix Φ* through the following equation:

$${Φ}^{*} = arg {max}_{Φ} {min}_{n} \{ E [ {\vert {d}_{n} \vert}^{2} ] + {\vert {g}_{n}^{H} Φ f \vert}^{2} \}$$

where Φ represents a reflection coefficient matrix corresponding to the one reconfigurable intelligent surface,
E[|dₙ|²] represents channel gain of a direct channel between the primary user and the n-th secondary user, where n is a positive integer from 1 to N,
f represents a mean value of channel coefficient of a channel between the one reconfigurable intelligent surface and the primary user, and gₙ represents a mean value of channel coefficient of a channel between the one reconfigurable intelligent surface and the n-th secondary user,

$${\vert {g}_{n}^{H} Φ f \vert}^{2}$$

represents channel gain of an equivalent channel from the primary user to the n-th secondary user via the one reconfigurable intelligent surface,
H represents a transpose operation, and

$$arg {max}_{Φ} {min}_{n} \{ E [ {\vert {d}_{n} \vert}^{2} ] + {\vert {g}_{n}^{H} Φ f \vert}^{2} \}$$

represents to traverse Φ and n, for a secondary user whose sum of channel gain of the one equivalent channel and a direct channel corresponding to the secondary user is maximum among the N secondary users, a Φ that maximizes the sum of channel gain of the one equivalent channel and the direct channel corresponding to the secondary user is determined as the optimal reflection coefficient matrix Φ*.
Solution 25. The electronic apparatus according to solution 18, wherein
the processing circuitry is configured to determine the optimal reflection coefficient matrix corresponding to the one reconfigurable intelligent surface to be: a reflection coefficient matrix, based on which a sum of channel gain of the one equivalent channel and a direct channel corresponding to a secondary user, whose sum of channel gain of the one equivalent channel and the direct channel is minimum in each subset containing K secondary users, is maximized,
where K is less than or equal to N.
Solution 26. The electronic apparatus according to solution 25, wherein the processing circuitry is configured to determine the optimal reflection coefficient matrix Φ* through the following equation:

$${Φ}^{*} = arg {max}_{{Φ}^{i}} f ( {Φ}^{i} )$$

where there has

$$f ( {Φ}^{i} ) = {max}_{{Φ}^{i}} {min}_{n ∈ {K}_{i}} \{ E [ {\vert {d}_{n} \vert}^{2} ] + {\vert {g}_{n}^{H} Φ f \vert}^{2} \}$$

where Φ represents a reflection coefficient matrix corresponding to the one reconfigurable intelligent surface,
Kᵢ represents the i-th subset containing K secondary users, where i is a positive integer greater than or equal to 1,
E[|dₙ|²] represents channel gain of a direct channel between the primary user and the n-th secondary user in Kᵢ, where n is a positive integer,
f represents a mean value of channel coefficient of a channel between the one reconfigurable intelligent surface and the primary user, and gₙ represents a mean value of channel coefficient of a channel between the one reconfigurable intelligent surface and the n-th secondary user in Kᵢ,

$${\vert {g}_{n}^{H} Φ f \vert}^{2}$$

represents channel gain of an equivalent channel from the primary user to the n-th secondary user in Kᵢ via the one reconfigurable intelligent surface,
H represents a transpose operation,
f(Φⁱ) represents to apply a reflection coefficient matrix Φⁱ, to maximize a sum of channel gain of the one equivalent channel and a direct channel corresponding to a secondary user, whose sum of channel gain of the one equivalent channel and a direct channel corresponding to the secondary user is minimum in Kᵢ, and

$${Φ}^{*} = arg {max}_{{Φ}^{i}} f ( {Φ}^{i} )$$

represents that Φⁱ with which f(Φ^{*}) is maximized is determined to be the optimal reflection coefficient matrix Φ*.
Solution 27. The electronic apparatus according to solution 17, wherein
the at least one reconfigurable intelligent surface comprises L reconfigurable intelligent surfaces, and the at least one equivalent channel corresponding to each secondary user comprises L equivalent channels, where L is a positive integer greater than 1, and
the plurality of secondary users comprises N secondary users, where N is a positive integer greater than 1.
Solution 28. The electronic apparatus according to solution 27, wherein the processing circuitry is configured to determine respective optimal reflection coefficient matrices corresponding to the L reconfigurable intelligent surfaces to be: reflection coefficient matrices, based on which a sum of channel gain of N×L equivalent channels from the primary user to the N secondary users via the L reconfigurable intelligent surfaces is maximized.
Solution 29. The electronic apparatus according to solution 28, wherein the processing circuitry is configured to determine the optimal reflection coefficient matrices Φ₁*, . . . , Φ_{L}* of the L reconfigurable intelligent surfaces through the following equation:

$${Φ}_{1}^{*} , … , {Φ}_{L}^{*} = arg {max}_{{Φ}_{1} , … , {Φ}_{L}} {‖ {\sum }_{l = 1}^{L} {G}_{l}^{H} {Φ}_{l} {f}_{l} ‖}^{2}$$

where Φₗ represents a reflection coefficient matrix corresponding to the l-th reconfigurable intelligent surface, l is a positive integer from 1 to L,
fₗ represents a mean value of channel coefficient of a channel between the l-th reconfigurable intelligent surface and the primary user, and g_{l,n} represents a mean value of channel coefficient of a channel between the l-th reconfigurable intelligent surface and the n-th secondary user, where n is a positive integer from 1 to N,
Gₗ=[g_{l,1}, . . . , g_{l,N}] represents a vector including mean value of channel coefficients of channels from the l-th reconfigurable intelligent surface to the N secondary users,

$${‖ {\sum }_{l = 1}^{L} {G}_{l}^{H} {Φ}_{l} {f}_{l} ‖}^{2}$$

represents a sum of channel gain of N×L equivalent channels from the primary user to the N secondary users via the L reconfigurable intelligent surfaces,
H represents a transpose operation, and

$${max}_{{Φ}_{1} , … , {Φ}_{L}} {‖ {\sum }_{l = 1}^{L} {G}_{l}^{H} {Φ}_{l} {f}_{l} ‖}^{2}$$

represents to traverse Φ₁, . . . , Φ_{L} and select Φ₁, . . . , Φ_{L} which maximize

$${‖ {\sum }_{l = 1}^{L} {G}_{l}^{H} {Φ}_{l} {f}_{l} ‖}^{2}$$

as the optimal reflection coefficient matrices

$${Φ}_{1}^{*} , … , {Φ}_{L}^{*} .$$

Solution 30. The electronic apparatus according to solution 27, wherein
the processing circuitry is configured to determine respective optimal reflection coefficient matrices corresponding to the L reconfigurable intelligent surfaces to be: reflection coefficient matrices, based on which a sum of channel gain of the L equivalent channels and a direct channel corresponding to a secondary user, whose sum of channel gain of the L equivalent channels and the direct channel is minimum among the N secondary users, is maximized.
Solution 31. The electronic apparatus according to solution 30, wherein the processing circuitry is configured to determine the optimal reflection coefficient matrices

$${Φ}_{1}^{*} , … , {Φ}_{L}^{*} .$$

corresponding to the L reconfigurable intelligent surfaces through the following equation:

$${Φ}_{1}^{*} , … , {Φ}_{L}^{*} = arg {max}_{{Φ}_{1} , … , {Φ}_{L}} {min}_{n} \{ E [ {\vert {d}_{n} \vert}^{2} ] + {\vert {\sum }_{l = 1}^{L} {g}_{i , n}^{H} {Φ}_{l} {f}_{l} \vert}^{2} \}$$

where Φₗ represents a reflection coefficient matrix corresponding to the l-th reconfigurable intelligent surface, l is a positive integer from 1 to L,
E[|dₙ|²] represents channel gain of a direct channel between the primary user and the n-th secondary user, where n is a positive integer from 1 to N,
fₗ represents a mean value of channel coefficient of a channel between the l-th reconfigurable intelligent surface and the primary user, and g_{l,n} represents a mean value of channel coefficient of a channel between the l-th reconfigurable intelligent surface and the n-th secondary user,

$${\vert {\sum }_{l = 1}^{L} {g}_{i , n}^{H} {Φ}_{l} {f}_{l} \vert}^{2}$$

represents a sum of channel gain of L equivalent channels from the primary user to the n-th secondary user via the L reconfigurable intelligent surfaces,
H represents a transpose operation, and

$$arg {max}_{{Φ}_{1} , … , {Φ}_{L}} {min}_{n} \{ E [ {\vert {d}_{n} \vert}^{2} ] + {\vert {\sum }_{l = 1}^{L} {g}_{i , n}^{H} {Φ}_{l} {f}_{l} \vert}^{2} \}$$

represents to traverse Φ₁, . . . , Φ_{L} and n, for a secondary user whose sum of channel gain of the L equivalent channels and a direct channel corresponding to the secondary user is minimum among the N secondary users, Φ₁, . . . , Φ_{L} that maximize the sum of channel gain of the L equivalent channels and the direct channel corresponding to the secondary user is determined as the optimal reflection coefficient matrices

$${Φ}_{1}^{*} , … , {Φ}_{L}^{*} .$$

Solution 32. The electronic apparatus according to solution 27, wherein
the processing circuitry is configured to determine respective optimal reflection coefficient matrices corresponding to the L reconfigurable intelligent surfaces to be: reflection coefficient matrices, based on which a sum of channel gain of the L equivalent channels and a direct channel corresponding to a secondary user, whose sum of channel gain of the L equivalent channels and the direct channel is maximum among the N secondary users, is maximized.
Solution 33. The electronic apparatus according to solution 32, wherein the processing circuitry is configured to determine the optimal reflection coefficient matrices

$${Φ}_{1}^{*} , … , {Φ}_{L}^{*}$$

corresponding to the L reconfigurable intelligent surfaces through the following equation:

$${Φ}_{1}^{*} , … , {Φ}_{L}^{*} = arg {max}_{{Φ}_{1} , … , {Φ}_{L}} {min}_{n} \{ E [ {\vert {d}_{n} \vert}^{2} ] + {\vert {\sum }_{l = 1}^{L} {g}_{l , n}^{H} {Φ}_{l} {f}_{l} \vert}^{2} \}$$

where Φₗ represents a reflection coefficient matrix corresponding to the l-th reconfigurable intelligent surface, l is a positive integer from 1 to L,
E[|dₙ|²] represents channel gain of a direct channel between the primary user and the n-th secondary user, where n is a positive integer from 1 to N,
fₗ represents a mean value of channel coefficient of a channel between the l-th reconfigurable intelligent surface and the primary user, and g_{l,n} represents a mean value of channel coefficient of a channel between the l-th reconfigurable intelligent surface and the n-th secondary user,

$${\vert {\sum }_{l = 1}^{L} {g}_{i , n}^{H} {Φ}_{l} {f}_{l} \vert}^{2}$$

represents a sum of channel gain of L equivalent channels from the primary user to the n-th secondary user via the L reconfigurable intelligent surfaces,
H represents a transpose operation, and

$$arg {max}_{{Φ}_{1} , … , {Φ}_{L}} {min}_{n} \{ E [ {\vert {d}_{n} \vert}^{2} ] + {\vert {\sum }_{l = 1}^{L} {g}_{i , n}^{H} {Φ}_{l} {f}_{l} \vert}^{2} \}$$

represents to traverse Φ₁, . . . , Φ_{L} and n, for a secondary user whose sum of channel gain of the L equivalent channels and a direct channel corresponding to the secondary user is maximum among the N secondary users Φ₁, . . . , Φ_{L} that maximize the sum of channel gain of the L equivalent channels and the direct channel corresponding to the secondary user is determined as the optimal reflection coefficient matrices

$${Φ}_{1}^{*} , … , {Φ}_{L}^{*} .$$

Solution 34. The electronic apparatus according to solution 27, wherein
the processing circuitry is configured to determine respective optimal reflection coefficient matrices corresponding to the L reconfigurable intelligent surfaces to be: reflection coefficient matrices, based on which a sum of channel gain of the L equivalent channels and a direct channel corresponding to a secondary user, whose sum of channel gain of the L equivalent channels and the direct channel is minimum in each subset containing K secondary users, is maximized,
where K is less than or equal to N.
Solution 35. The electronic apparatus according to solution 34, wherein the processing circuitry is configured to determine the optimal reflection coefficient matrices

$${Φ}_{1}^{*} , … , {Φ}_{L}^{*}$$

of the L reconfigurable intelligent surfaces through the following equation:

$${Φ}_{1}^{*} , … , {Φ}_{L}^{*} = arg {max}_{{Φ}_{1} , … , {Φ}_{L}} {min}_{n} f ( {Φ}_{1}^{i} , … , {Φ}_{L}^{i} )$$

where there has

$$f ( {Φ}_{1}^{i} , … , {Φ}_{L}^{i} ) = arg {max}_{{Φ}_{1}^{i} , … , {Φ}_{L}^{j}} {min}_{n = {K}_{j}} \{ E [ {\vert {d}_{n} \vert}^{2} ] + {\vert {\sum }_{l = 1}^{L} {g}_{l , n}^{H} {Φ}_{l} {f}_{l} \vert}^{2} \} ,$$

where Φₗ represents a reflection coefficient matrix corresponding to the l-th reconfigurable intelligent surface, l is a positive integer from 1 to L,
Kᵢ represents the i-th subset containing K secondary users, where i is a positive integer greater than or equal to 1,
E[|dₙ|²] represents channel gain of a direct channel between the primary user and the n-th secondary user in Kᵢ, where n is a positive integer,
fₗ represents a mean value of channel coefficient of a channel between the l-th reconfigurable intelligent surface and the primary user, and g_{l,n} represents a mean value of channel coefficient of a channel between the l-th reconfigurable intelligent surface and the n-th secondary user in Kᵢ,

$${\vert {\sum }_{l = 1}^{L} {g}_{l , n}^{H} {Φ}_{l} {f}_{l} \vert}^{2}$$

represents a sum of channel gain of L equivalent channels from the primary user to the n-th secondary user in Kᵢ via the L reconfigurable intelligent surfaces,
H represents a transpose operation,

$$f ( {Φ}_{1}^{i} , … , {Φ}_{L}^{i} )$$

represents to apply a reflection coefficient matrix

$${Φ}_{1}^{i} , … , {Φ}_{L}^{i} ,$$

maximize a sum of channel gain of the L equivalent channels and a direct channel corresponding to a secondary user, whose sum of channel gain of the L equivalent channels and a direct channel corresponding to the secondary user is minimum in Kᵢ, and

$${Φ}_{1}^{*} , … , {Φ}_{L}^{*} = arg {max}_{{Φ}_{1}^{i} , … , {Φ}_{L}^{i}} f ( {Φ}_{1}^{i} , … , {Φ}_{L}^{i} )$$

represents that

$${Φ}_{1}^{i} , … , {Φ}_{L}^{i}$$

with which

$$f ( {Φ}_{1}^{i} , … , {Φ}_{L}^{i} )$$

is maximized are determined to be the optimal reflection coefficient matrices

$${Φ}_{1}^{*} , … , {Φ}_{L}^{*} .$$

Solution 36. A method for wireless communications, comprising:
receiving at least one sensing signal from a primary user, through at least one equivalent channel corresponding to a direct channel between the primary user and an electronic apparatus, for judging whether the primary user occupies a predetermined frequency band used by the direct channel and the at least one equivalent channel, wherein the at least one equivalent channel is established between the electronic apparatus and the primary user by means of at least one reconfigurable intelligent surface.
Solution 37. A method for wireless communications, comprising:
judging, based on at least one sensing signal received by each secondary user among a plurality of secondary users through at least one equivalent channel corresponding to a direct channel between a primary user and the secondary user, whether the primary user occupies a predetermined frequency band used by the direct channel and the at least one equivalent channel,
wherein the at least one equivalent channel corresponding to each secondary user is established between the primary user and the secondary user by means of at least one reconfigurable intelligent surface.
Solution 38. A computer-readable storage medium having stored thereon computer-executable instructions that, when executed, implements the method for wireless communications according to solution 36 or 37.

1. An electronic apparatus for wireless communications, comprising:
at least one processor; and
at least one memory including computer program code, where the at least one memory and the computer program code are configured, with the at least one processor, to cause the electronic apparatus to at least:
receive at least one sensing signal from a primary user, through at least one equivalent channel corresponding to a direct channel between the primary user and the electronic apparatus, for judging whether the primary user occupies a predetermined frequency band used by the direct channel and the at least one equivalent channel, wherein the at least one equivalent channel is established between the electronic apparatus and the primary user by means of at least one reconfigurable intelligent surface.

2. The electronic apparatus according to claim 1, wherein
reflection coefficient(s) of a reflection unit of each of the at least one reconfigurable intelligent surface is set based on an optimal reflection coefficient matrix corresponding to the reconfigurable intelligent surface, wherein the optimal reflection coefficient matrix is determined so as to maximize channel gain of channel(s) obtained based on the at least one equivalent channel.

3. The electronic apparatus according to claim 2, wherein in a case where a change in a communication system to which the electronic apparatus belongs satisfies predetermined conditions, the optimal reflection coefficient matrix is re-determined.

4. The electronic apparatus according to claim 3, wherein
the predetermined conditions include an access and/or exit of equipment in the communication system, and/or
the predetermined condition includes change(s) in position(s) of the electronic apparatus and/or the primary user.

5. The electronic apparatus according to claim 2, wherein
the at least one memory and the computer program code are configured, with the at least one processor, to cause the electronic apparatus to determine, based on channel statistical information of channels between the at least one reconfigurable intelligent surface and the primary user as well as the electronic apparatus, an optimal reflection coefficient matrix respectively corresponding to the at least one reconfigurable intelligent surface.

6. The electronic apparatus according to claim 5, wherein
the at least one reconfigurable intelligent surface comprises one reconfigurable intelligent surface, and
the at least one memory and the computer program code are configured, with the at least one processor, to cause the electronic apparatus to determine the optimal reflection coefficient matrix to be: a reflection coefficient matrix, based on which channel gain of an equivalent channel from the primary user to the electronic apparatus via the one reconfigurable intelligent surface is maximized.

7. The electronic apparatus according to claim 6, wherein the at least one memory and the computer program code are configured, with the at least one processor, to cause the electronic apparatus to determine the optimal reflection coefficient matrix Φ* through the following equation:
$${Φ}^{*} = arg {max}_{Φ} {\vert {g}^{H} Φ f \vert}^{2}$$
where Φ represents a reflection coefficient matrix corresponding to the one reconfigurable intelligent surface,
f represents a mean value of channel coefficient of a channel between the one reconfigurable intelligent surface and the primary user, and g represents a mean value of channel coefficient of a channel between the one reconfigurable intelligent surface and the electronic apparatus,

|g^{H}Φf|² represents channel gain of an equivalent channel from the primary user to the electronic apparatus via the one reconfigurable intelligent surface,
H represents a transpose operation, and
$$arg {max}_{Φ} {\vert {g}^{H} Φ f \vert}^{2}$$
represents to traverse Φ and select Φ which maximizes |g^{H}Φf|² as the optimal reflection coefficient matrix Φ*.

8. The electronic apparatus according to claim 5, wherein
the at least one reconfigurable intelligent surface comprises L reconfigurable intelligent surfaces, and the at least one equivalent channel comprises L equivalent channels, where L is a positive integer greater than 1, and
the at least one memory and the computer program code are configured, with the at least one processor, to cause the electronic apparatus to determine respective optimal reflection coefficient matrices corresponding to the L reconfigurable intelligent surfaces to be: reflection coefficient matrices, based on which channel gain of a combined channel formed by the L equivalent channels from the primary user to the electronic apparatus via the L reconfigurable intelligent surfaces is maximized.

9. The electronic apparatus according to claim 8, wherein the at least one memory and the computer program code are configured, with the at least one processor, to cause the electronic apparatus to determine the optimal reflection coefficient matrices
$${Φ}_{1}^{*} , … , {Φ}_{L}^{*}$$
corresponding to the L reconfigurable intelligent surfaces through the following equation:
$${Φ}_{1}^{*} , … , {Φ}_{L}^{*} = arg {max}_{{Φ}_{1} , … , {Φ}_{L}} {\vert {\sum }_{l = 1}^{L} {g}_{l}^{H} {Φ}_{l} {f}_{l} \vert}^{2}$$
where l represents a positive integer from 1 to L,
Φₗ represents a reflection coefficient matrix corresponding to the l-th reconfigurable intelligent surface,
fₗ represents a mean value of channel coefficient of a channel between the l-th reconfigurable intelligent surface and the primary user, and gₗ represents a mean value of channel coefficient of a channel between the l-th reconfigurable intelligent surface and the electronic apparatus,
$${\vert {\sum }_{l = 1}^{L} {g}_{l}^{H} {Φ}_{l} {f}_{l} \vert}^{2}$$
represents channel gain of a combined channel formed by the L equivalent channels from the primary user to the electronic apparatus via the L reconfigurable intelligent surfaces,
H represents a transpose operation, and
$$arg {max}_{{Φ}_{1} , … , {Φ}_{L}} {\vert {\sum }_{l = 1}^{L} {g}_{l}^{H} {Φ}_{l} {f}_{l} \vert}^{2}$$
represents to traverse Φ₁, . . . , Φ_{L} and select Φ₁, . . . , Φ_{L} which maximize
$${\vert {\sum }_{l = 1}^{L} {g}_{l}^{H} {Φ}_{l} {f}_{l} \vert}^{2}$$
as the optimal reflection coefficient matrices
$${Φ}_{1}^{*} , … , {Φ}_{L}^{*}$$

10. The electronic apparatus according to claim 1, wherein the at least one memory and the computer program code are configured, with the at least one processor, to cause the electronic apparatus to: compare the calculated statistics about the at least one sensing signal with a predetermined threshold, to determine whether the primary user occupies the predetermined frequency band.

11. The electronic apparatus according to claim 2, wherein
the at least one memory and the computer program code are configured, with the at least one processor, to cause the electronic apparatus to transmit channel statistical information of channels between the at least one reconfigurable intelligent surface and the primary user as well as the electronic apparatus to a fusion center, for the fusion center to determine the optimal reflection coefficient matrix based on the channel statistical information and channel statistical information received from other electronic apparatus.

12. (canceled)

13. An electronic apparatus for wireless communications, comprising:
at least one processor; and
at least one memory including computer program code, where the at least one memory and the computer program code are configured, with the at least one processor, to cause the electronic apparatus to at least:
judge, based on at least one sensing signal received by each secondary user among a plurality of secondary users through at least one equivalent channel corresponding to a direct channel between a primary user and the secondary user, whether the primary user occupies a predetermined frequency band used by the direct channel and the at least one equivalent channel,
wherein the at least one equivalent channel corresponding to each secondary user is established between the primary user and the secondary user by means of at least one reconfigurable intelligent surface.

14. The electronic apparatus according to claim 13, wherein
reflection coefficient(s) of a reflection unit of each of the at least one reconfigurable intelligent surface is set based on an optimal reflection coefficient matrix corresponding to the reconfigurable intelligent surface, wherein the optimal reflection coefficient matrix is determined so as to maximize channel gain of channel(s) obtained based on the at least one equivalent channel.

15. The electronic apparatus according to claim 14, wherein in a case where a change in a communication system to which the primary user and the plurality of secondary users belongs satisfy predetermined conditions, the optimal reflection coefficient matrix is re-determined.

16. The electronic apparatus according to claim 15, wherein
the predetermined conditions include an access and/or exit of equipment in the communication system, and/or
the predetermined condition includes change(s) in position(s) of the primary user and/or at least one secondary user in the plurality of secondary user.

17. The electronic apparatus according to claim 13, wherein
the at least one memory and the computer program code are configured, with the at least one processor, to cause the electronic apparatus to determine, based on channel statistical information of channels between the at least one reconfigurable intelligent surface and the primary user as well as each secondary user among the plurality of secondary users obtained from the secondary user, an optimal reflection coefficient matrix respectively corresponding to the at least one reconfigurable intelligent surface.

18. The electronic apparatus according to claim 17, wherein
the at least one reconfigurable intelligent surface comprises one reconfigurable intelligent surface, and the at least one equivalent channel corresponding to each secondary user comprises one equivalent channel, and
the plurality of secondary users comprises N secondary users, where Nis a positive integer greater than 1.

19. The electronic apparatus according to claim 18, wherein the at least one memory and the computer program code are configured, with the at least one processor, to cause the electronic apparatus to determine the optimal reflection coefficient matrix corresponding to the one reconfigurable intelligent surface to be: a reflection coefficient matrix, based on which a sum of channel gain of N equivalent channels from the primary user to the N secondary users via the one reconfigurable intelligent surface is maximized.

20. (canceled)

21. The electronic apparatus according to claim 18, wherein
the at least one memory and the computer program code are configured, with the at least one processor, to cause the electronic apparatus to determine the optimal reflection coefficient matrix corresponding to the one reconfigurable intelligent surface to be: a reflection coefficient matrix, based on which a sum of channel gain of the one equivalent channel and a direct channel corresponding to a secondary user, whose sum of channel gain of the one equivalent channel and the direct channel is minimum among the N secondary users, is maximized.

22.-35. (canceled)

36. A method for wireless communications, comprising:
receiving at least one sensing signal from a primary user, through at least one equivalent channel corresponding to a direct channel between the primary user and an electronic apparatus, for judging whether the primary user occupies a predetermined frequency band used by the direct channel and the at least one equivalent channel, wherein the at least one equivalent channel is established between the electronic apparatus and the primary user by means of at least one reconfigurable intelligent surface.

37.-38. (canceled)
